(19) United States
(12) Patent Application Publication
(10) Pub. No.: US 2002/0065879 A1
(43) Pub. Date: May 30, 2002

(54) Client server system with thin client architecture

(76) Inventors: Jesse Ambrose, San Jose, CA (US); Gilberto Arnalz, Redwood City, CA (US); John L. Coker, Hillsborough, CA (US); Thanh Diec, Sunnyvale, CA (US); Samuel Shin-Yi Hahn, Saratoga, CA (US); Ernst Katchour, Los Altos, CA (US); Thomas M. Rothwein, San Jose, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/866,877

(22) Filed: May 30, 2001

Related U.S. Application Data
(63) Continuation of application No. PCT/US99/28414, filed on Nov. 30, 1999.
(60) Provisional application No. 60/110,191, filed on Nov. 30, 1998.

(51) Int. Cl. G06F 15/16; G06F 9/44

(52) U.S. Cl. 709/203; 709/315

(57) ABSTRACT

Web based client-server systems with thin client architecture. More specifically, it relates to a method and system for transferring service requests and responses to the requests between a thin client and an enterprise server in a client-server system. Preferably the interconnection is a persistent interconnection.

### FIELD OF THE INVENTION

The invention relates to Web based client-server systems with thin client architecture. More specifically, it relates to a method and system for transferring service requests and responses to the requests between a thin client and an enterprise server in a client-server system.

### BACKGROUND

The acceptance of the TCP/IP protocol and the World Wide Web has changed the rules for creating and deploying enterprise applications, validating a multitiered application architecture. One advantage of the World Wide Web (TCP/IP) is the ability to adapt this technology to client-server business applications.

One consequence has been the development and utilization of technologies that move the interface to the user, while leaving the application on the server, that is, a thin client. A true thin client would provide the ability to configure applications once and deploy the applications in the manner best suited to end-users. True web-based thin clients can be browser based, using an HTML interface with CGI, or Java based, as for use with a Unix based system, or ActiveX based, as for use with Microsoft Windows 95 or Windows 98. One advantage of Java based thin clients and ActiveX based thin clients is that they preserve any graphical user interfaces of the server. This is particularly desirable for business applications, which can take advantage of the TCP/IP protocol without the business unfriendly aspects of HTML and CGI.

A clear need exists for a true thin client that preserves and combines the graphical user interfaces popularized by personal computers and the highly cost efficient architectures of main frame computers, with applications executing on main frame computer resources.

A further need exists for a client-server application that can be substantially configured once, with substantially one application definition, and deployed across an enterprise with a minimum of reconfiguration at the client.

A still further need exists for a thin client based application that is connected to a live session on the server, with substantially immediate responses and field level validation.

Additionally, a clear need exists for a thin client architecture method and system that fully exploits the benefits of the Web and the TCP/IP protocol by making available a true thin client technology for deploying software applications such as sales and service applications to users with no previously installed client-side software.

### SUMMARY OF THE INVENTION

One aspect of our invention is a client server system having a thin client interface. The system includes at least one client on a client computer and an object manager and an application that can reside on one or on more servers. The object manager is interposed between the client and the application server. The application server has one or more of business objects, and business components. The application server may include a database server. In some embodiments, the thin client may be adapted to a pre-existing user interface without any necessity for redesigning or reprogramming of the user interface. The thin client architecture additionally provides persistent sessions between the client and server.

Object manager run-time engines operate on the business objects and business components. The business objects and business components contain applets and application objects. Additionally, object manager run time engines enforce repository-defined business processes and rules.

Application objects may execute on the client. Alternatively, only user interface objects executing on the client.

Network interconnectivity is provided by session-based network protocols that connect the client to the object manager.

A further aspect of the invention is a method and system for packaging data transmissions to a client. For example, in some embodiments, a client may transmit data to a server upon entry without requiring additional operator actuation, such as actuation of a “send” button. In addition, routine transmissions from the server to the client may automatically include notifications, such as alerts and alarms.

A further aspect of our invention is a method of connecting a client and one or more servers in a client server network. In this embodiment, the client is a thin client, and the one or more servers include an object manager and an application residing on one or more servers. The object manager is interposed between the client and the application server. The application server has one or more of business objects, and business components, and instantiating the one or more business objects, and establishes the client-server connection which is a session based network connection between the thin client and the one or more servers. The method further includes instantiating object manager run-time engines to operate on the business objects and business components. The business objects and business components include applets and application objects.

A further aspect of the method of the invention is that the object manager run time engines enforce repository-defined business processes and rules. The application objects may execute on the client. Typically, user interface objects also execute on the client.

### THE FIGURES

The invention may be understood by reference to the Figures appended hereto.

FIG. 1 illustrates the concept of a platform for an extended enterprise.

FIG. 2 illustrates the capability of “Configure Once, Deploy Anywhere” of the method and system of our invention.

FIG. 3 illustrates the thin client user interface in ActiveX, accessible from, for example, Microsoft Windows 95 or Microsoft Windows 98.

FIG. 4 illustrates thin client architecture-scalable support for ActiveX, Java and HTML thin clients.

FIG. 5 illustrates a Thin Client for Windows (“TCW”), according to an embodiment of the invention.

FIG. 6 illustrates a Java Thin Client (“JTC”), according to an embodiment of the invention.

FIG. 7 illustrates software components comprising the Siebel Server architecture, according to an embodiment of the invention.

FIG. 8 illustrates a Siebel Thin Client-support for leading Internet standards, according to an embodiment of the invention.

FIG. 9 illustrates a Siebel Thin Client and the Siebel n-tiered architecture, according to an embodiment of the invention.

FIG. 10 illustrates architectural elements of Siebel Remote and Siebel Replication Manager, according to an embodiment of the invention.

### DETAILED DESCRIPTION OF THE INVENTION

With the thin client of the method and system of our invention, enterprises can deploy the world's leading enterprise relationship management system through the Web (that is utilizing TCP/IP), taking advantage of a fully Web-based, TCP/IP compliant, multitiered architecture with persistent sessions. This eliminates the need to install software in remote field locations or upgrade thousands of older-generation PCs to support the needs of a richly featured, modern enterprise application.

Instead of consuming costly desktop computing cycles or memory, Web-based thin client applications such as Siebel Sales Enterprise or Siebel Service Enterprise can execute on shared servers where computing resources can be pooled for maximum efficiency across all users in the enterprise. And instead of upgrading each desktop with every new release of software, upgrades can be deployed once to the server and are immediately available to all connecting users.

The method and system contemplate an end-user at the client entering a request for service by the enterprise server. The object manager contains rules in the form of objects representing real concepts. The enterprise server services the request on the enterprise server in accordance with the object, and returns a response to the request from the enterprise server to the object manager. The object manager returns the response to the request to the client.

The object manager is a multi-tasking, multi-thread object manager capable of handling requests from multiple clients. The object manager does this by maintaining the status of each client in a separate object manager thread. The objects are business objects. They are chosen from the group consisting of horizontal applications, vertical applications, and internet applications.

The horizontal applications are function specific applications, such as sales applications, marketing applications, and customer service applications. The vertical applications are industry specific applications, such as finance, insurance, consumer goods, pharmaceuticals, and communications applications. The internet applications include self-service applications, e-commerce applications, and channel management applications.

The objects perform a number of services including, providing a template for client requests for services, providing a template for interface to the enterprise server, and providing a template for returning a response from the enterprise server to the web server.

The architecture of the method and system of our invention fully exploits the benefits of the Web, that is, TCP/IP, by making available a true thin client technology for deploying software applications such as sales and service applications to connected users.

The thin-client method and system of our invention provides a common metadata framework for defining and instantiating a single application across different client and server platforms. By a “metadata framework” or “schema” is meant a data dictionary or directory which contains “data about the data” in the database. The metadata, which may be a database itself, or a set of files, contains the definition, characteristics, structure, and usage of the data, including information about the data (fields, groups, records, files, file relationships, user interfaces, file types, file formats, data constraints, and databases), the processes (programs, reports, screens, transactions, and jobs), and environment (hardware and software). The common metadata framework results in only one metadata repository, one layout definition, one business logic, one set of data models, and one metadata manipulation tool.

A further aspect of our invention is the provision of players for different client environments where each player renders a user interface according to the common metadata definition.

Another aspect of the method and system of our invention is the use of one or more metadata servers for delivering metadata to all players as well as a business logic server that instantiates logic for the players based on the business logic metadata.

A further aspect of the method and system of our invention is the capability of delivering information from a server to a client that minimizes the number and size of communications between the client and server. This encompasses, for example, server components for grouping notifications destined for the client along with a client component for “unpacking” notification groups received from the server and a method for distributing individual messages from the client component to the graphical user interface. A further aspect of our invention is a method and system for sending notification groups as part of a response to client requests. This avoids the costly creation of a separate server-to-client communication channel.

The method and system of our invention dramatically reduces total costs of ownership for many distributed applications, providing a platform for deploying mission-critical front office applications throughout an extended enterprise. This also includes the ability to configure applications once and then deploy them in the manner most suited to their users-to mobile laptops or handhelds in the field, thin clients in the call center, or thin clients at their strategic partners or end customers.

With the thin client, numerous software solutions can be reached beyond the enterprise's own employees into the extended enterprise of partners, resellers and end customers. With a software application such as Siebel Service Enterprise deployed through the thin client, call center-based representatives can solve service issues for customers.

The object manager is a multi-tasking, multi-thread object manager capable of handling requests from multiple clients. The object manager does this by maintaining the status of each client in a separate object manager thread. The objects are business objects. They are chosen from the group consisting of horizontal applications, vertical applications, and internet applications.

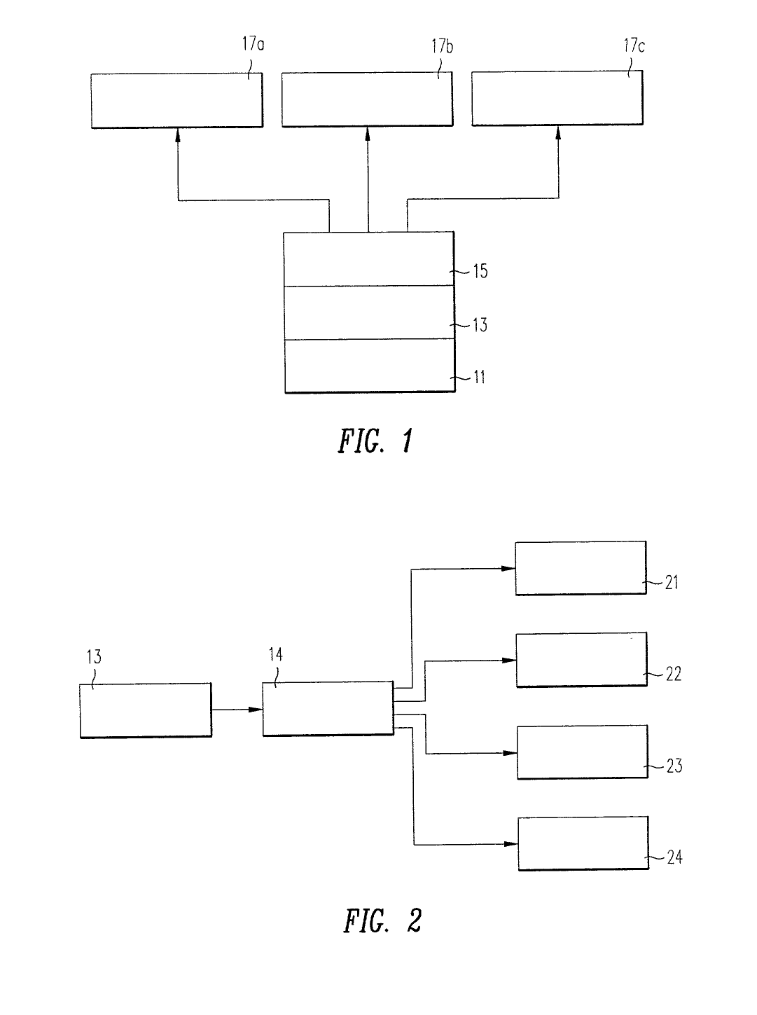

The concept of a platform for an extended enterprise is illustrated in FIG. 1. The platform is built on a base of business objects, 11, tools, 13, and a thin client, 15. These support horizontal applications, 17a, vertical applications, 17b, and internet applications, 17c. Exemplary horizontal applications, 17a, include sale, marketing, and customer service. Exemplary vertical applications, 17b, include finance, insurance, consumer goods, pharmaceuticals, and communications. Internet applications, 17c, include, for example, self-service, e-commerce, and channel management.

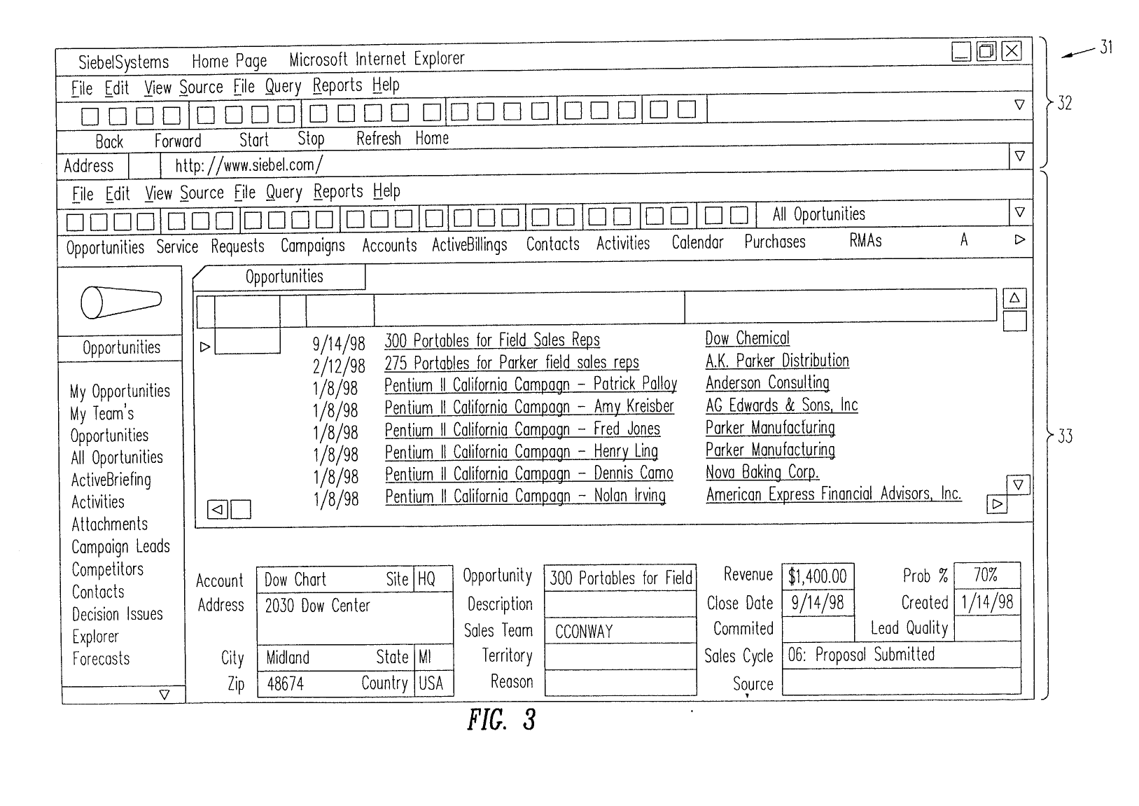

The method and system of our invention provides the capability of “Configure Once, Deploy Anywhere” as shown in FIG. 2. FIG. 2 shows the configuration environment, with the tools application, 13, providing one application definition, 14, to mobile clients, 21, desktop users, 22, TCP/IP users, 23, and handheld users, 24. With thin client capability, applications such as Siebel Sales Enterprise, Siebel Service Enterprise or Siebel Internet Self-Service, can be configured through a single, graphical configuration environment. Customers, such as mobile clients, 21, connected clients, 22, thin clients, 23, and handheld users, 24, can deploy their configured applications to their mobile users in the field, working from a mobile client or to their connected users working from a Web browser.

This may be accomplished using all of the leading thin client technologies—ActiveX, Java and HTML to ensure that all types of TCP/IP, internet, intranet, browser-based users can access the applications whatever their desktop platform or connectivity to the Internet or corporate Intranet.

For enterprise users, the thin client method and system makes available highly interactive ActiveX and Java-based user interfaces that avoid the limitations of HTML's page-based processing. Instead of clicking a “submit” button at the end of a complete screen and waiting for approval from a sessionless Web server, users of the thin client of our invention can benefit from immediate responses to any data they enter. The thin client is already connected to a live session on the server, and the user interface applies field-level validation whenever the user hits a tab button on their keyboard.

Thin Client in ActiveX

The thin client of our invention supports the enterprise's Windows-based users with a high-performance thin client that supports the look and feel of the distributed and/or replicated data base management system. The ActiveX version of the thin client of our invention looks and works like a connected or mobile client, allowing users already familiar with the underlying host applications user interface to access such applications through a standard Web browser without having to install any software on their desktops. For the enterprise IT department, that means applications can be deployed with zero maintenance required at the user desktop.

Thin Client in Java

The Java thin client uses 100% pure Java to support users accessing the host-based applications from Java-enabled environments. Like the ActiveX thin client, the Java thin client offers full support for highly interactive, browser-like user interface.

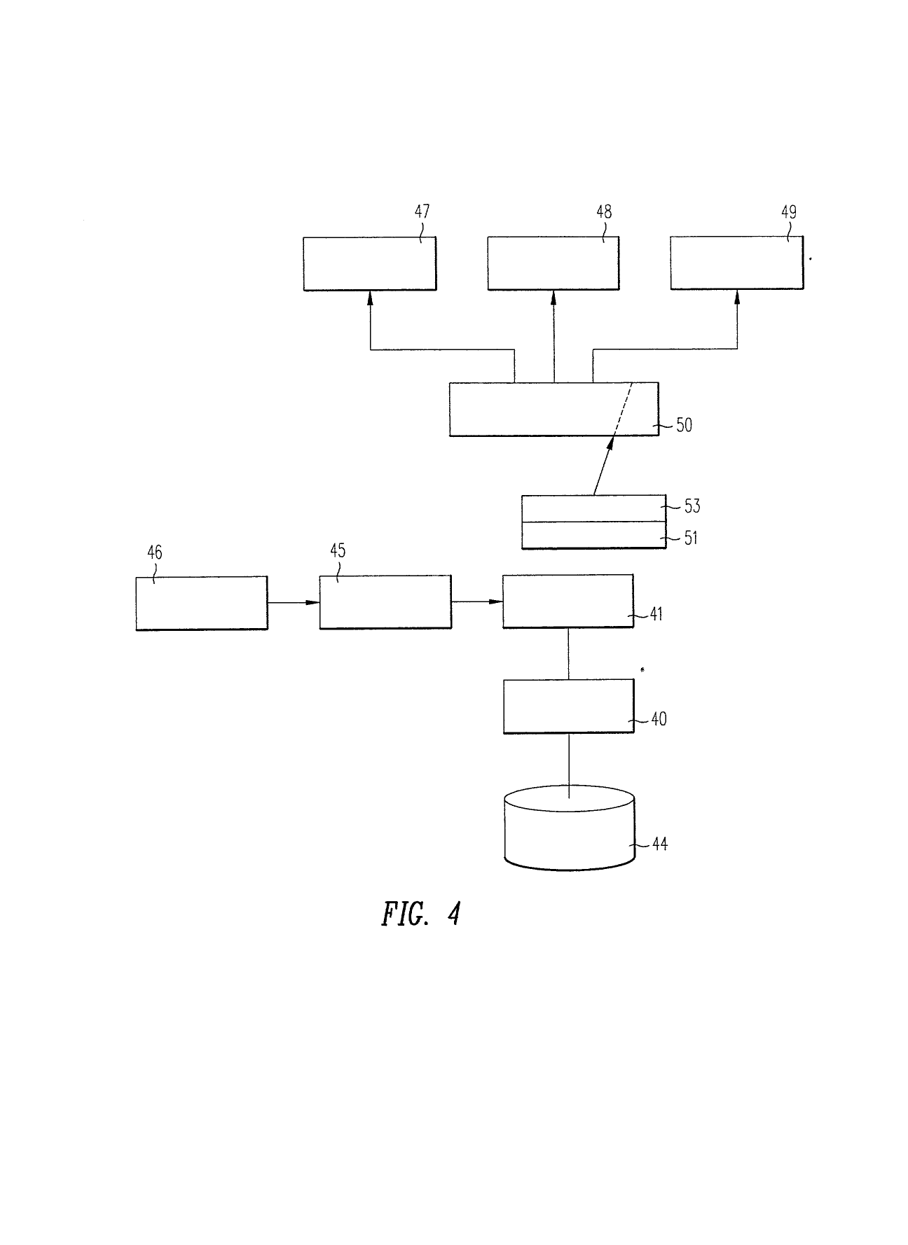

FIG. 3 shows the thin client user interface, 31, in ActiveX, accessible from a Microsoft Windows 95 or Microsoft Windows 98. The interface, 31, has the conventional Microsoft Windows 95 interface, 32, in the upper portion of the screen, 31, and the ActiveX supported application interface, 33, with application specific information and blocks, in the lower portion of the screen, 31.

Object Manager: Supporting Enterprise-wide Scalability

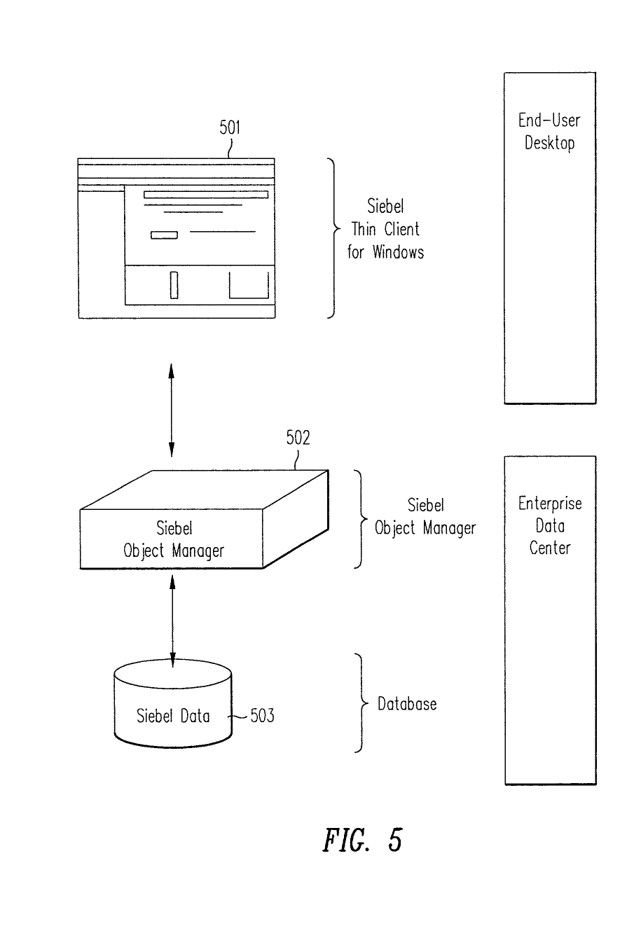

FIG. 4 shows the overall architecture of the system and method of the invention. An object manager, 41, provides interconnectivity to the application servers, as a database manager, 43, and a database, 44, to the application definitions, 45, an optional tools application, 46, and the thin clients, as the ActiveX thin client 47, for Microsoft Windows 95 and 98, the Java thin client, 48, for Unix, Linux, and the like, and the HTML thin client, 49. The thin clients, 47, 48, and 49, are connected to the object manager, 41, through TCP/IP connections, 50. In the case of the HTML thin client, the interconnection is through a web engine 51, and a web server, 53.

The Object Manager, 41, of our invention manages the enterprise's business rules in the form of Business Objects which are highly configurable software representations of business concepts such as “accounts,” “contacts,” “opportunities” and “service requests.” The thin clients, 47, 48, and 49, of our invention connect to the Object Manager, 41, to access the application's business logic. Object Managers, 41, are hosted in a server environment and deliver:

Multi-user Support.

Designed for enterprise-class scalability and robustness, the multi-threaded, multi-processing Object Manager, 41, can support large numbers of thin client users. Each Object Manager, 41, can handle requests from multiple thin clients, 47, 48, 49, and share process overhead across all the thin clients, 47, 48, 49. Each active thread in an Object Manager corresponds to an active persistent client session. The state of each client, 47, 48, 49, is maintained by the Object Manager thread, thus avoiding the overhead of setting up a new session for each request. Object Managers running on multiple server machines are preferably dynamically load-balanced to serve incoming clients in an optimal manner.

Dynamic Load-Balancing across Multiple Servers.

The Server environment can dynamically measure CPU load on each server running an Object Manager to direct requests to the least-loaded Object Manager.

High Resilience and Availability.

As part of the Application Server environment of our invention, the Object Manager, 41, benefits from high-resiliency/high-availability features such as automatic failover across server machines and extensive server monitoring. If an Object Manager, 41, process fails, alternate Object Manager, 41, processes can be brought up to take over the clients of the failed process.

Full Support for Business Objects.

By supporting Business Objects, the Object Manager, 41, can leverage the customer's investments in configuring Enterprise Applications. The Object Manager, 41, like all other components of the n-tiered, TCP/IP and Web-based architecture, can be fully configured using a tools module or application, 13, as a graphical application configuration tool. Because the Object Manager, 41, supports a full range of Business Objects, 17a, 17b, 17c, enterprises only configure their application once, and can then choose to deploy it over the thin client of the method and system of our invention without writing separate configurations for the thin client and other communications systems.

Common Administration Framework.

The Object Manager, 41, can utilize the Server's administration framework for monitoring and administration. This makes it simple for server administrators to manage the Object Manager, 41, the same way as they would manage other components.

Additional Description of Illustrated Embodiments of the Invention

As a skilled artisan will recognized, “Thin Client” describes applications in which the main tiers of the application, such as the user interface, the application logic, and the database, are separated from each other. For example, only the user interface needs to be placed on the user's desktop machine while all application logic and data storage execute on enterprise servers. The resulting client-side user interface uses minimal amounts of RAM and CPU and can be accessed dynamically over the network from any connected machine. Accordingly, there is no real software install process the user needs to go through to access the thin client application.

In addition, where a user interface already exists, such as for use with a conventional client, then the thin client may be deployed without requiring any rewriting of the user interface programming. For example, embodiments of the thin client disclosed herein in combination with the other disclosed elements provide an environment in which the same user interface (and other components) may be used in both thin client and conventional client applications.

Well-designed thin client architectures have other characteristics and associated benefits, such as:

Very Small Software Footprint on the User's Desktop.

This allows the application to take up a minimal amount of CPU and RAM on the user's desktop, allowing the Thin Client application to be accessed from machines that have relatively little RAM or CPU capacity. It also means that the application can be run comfortably alongside other desktop applications.

Dynamically Accessible Over the Network.

Thin Client user interfaces should be accessible on demand from a server URL by any client machine that meets the minimum requirements for RAM and operating system. To be available dynamically, thin client interfaces should be small in size (even 5 megabytes requires 25 minutes to download at 28.8 Kb) and use one of the leading internet-based component technologies, such as Java and ActiveX. By using Java or ActiveX, the application's user interface can be downloaded from the network on demand in the form of small software components (e.g., “applets” in the case of Java and “controls” in the case of ActiveX.

No Business Logic on the Client Machine.

All application rules and logic may be executed on a server, reducing the load on the client CPU and cleanly separating the application layer from the user interface (also known as the presentation layer). In this way, any modifications to application logic are immediately available to all thin client users, without requiring new software to be distributed or downloaded by each user.

The following text discusses two embodiments of the invention, one a Thin Client for Windows (“TCW”) and the other a Java Thin Client (“JTC”). As an artisan of ordinary skill will recognize, thin clients may be expressed in other embodiments and even the two embodiments discussed below may be expressed other ways without departing from the novelty disclosed herein.

Siebel Thin Client for Windows (“TCW”)

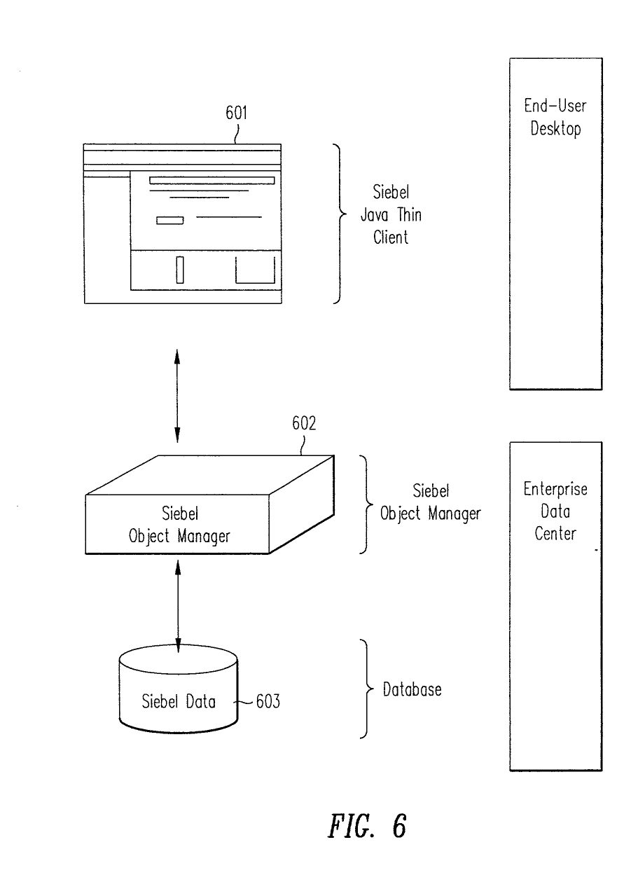

Embodiments of Siebel TCW provide a deployment option for customers who look to deploy Enterprise Applications over the Intranet or Internet. As shown in FIG. 5, a deployment of TCW may comprise 3 main layers—a user interface 501 that renders the presentation on the client, an object manager 502 (i.e., a Siebel Object Manager (“SOM”)) that performs business logic processing, and a database 503 that maintains data storage. In this embodiment, the resulting client-side user interface uses minimal amount of RAM and CPU and can be accessed dynamically over the network from any connected machine.

Those benefiting from the Siebel Thin Client for Windows include:

Customers who want to lower the costs of software and hardware ownerships,

Customers who want fast deployment of the Enterprise applications,

Customers who want to perform real-time integration from middle tier servers,

Customers who have Windows as their primary OS platform, and

Customers who have concluded that the feature and functionality set provided by Thin Client for Windows can meet their business requirements.

Enterprise Applications that may be supported by embodiments of a TCW deployment include: All Enterprise Applications, such as Sales, Service, Call Center, and Field Services. Additionally, vertical applications, such as Siebel Finance, and various Siebel language versions, may also be supported.

Siebel Java Thin Client (“JTC”)

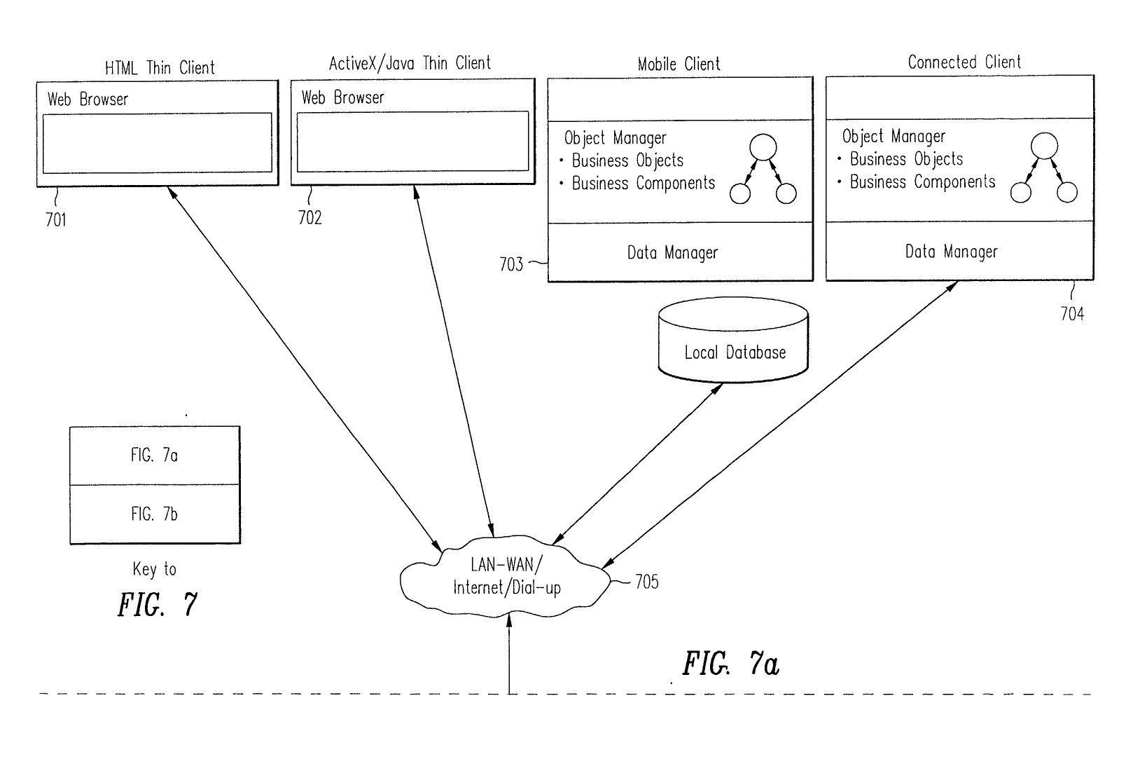

The following text discusses an embodiment of the JTC (i.e., the Siebel Java Thin Client). Embodiments of the JTC provide non-Windows platform deployment solution for the Enterprise Applications with a high ROI in the cost-conscious networked computing environments. JTC delivers a highly interactive interface into applications that places minimal demands on the user's desktop environment by using less processor capacity, memory, and disk space than traditional client/server applications. As shown in FIG. 6, a deployment of JTC may comprise 3 main layers—a user interface 601 that renders the presentation on the client, an object manager 602 (i.e., a Siebel Object Manager (“SOM”)) that performs business logic processing, and a database 603 that maintains data storage.

Embodiments of JTC may be built on 100% pure Java technology—to dramatically reduce the costs of deploying Enterprise Applications to new and existing users.

As discussed above, the JTC (as well as the TCW) may deliver the same user interface as a conventional Connected Client, leveraging customers' investments in training and previously built user interfaces.

Those who should use the JTC include:

Customers who want to lower the costs of software and hardware ownerships,

Customers who want fast deployment of Enterprise applications,

Customers who want to perform real-time integration from middle tier servers,

Customers who have non-Windows as their primary OS platform, and

Customers who recognize that the current functionality set provided by JTC can meet their business requirements.

Enterprise Applications supported by deployments of JTC include: All Enterprise Applications—Sales, Service, Call Center, and Field Services.

TCW and JTC are both OS platform solutions. TCW may function more satisfactorily on the Windows platform (e.g., Windows 95, 98 & NT) while JTC may function more satisfactorily on Non-Windows (e.g. UNIX or MacOS) platforms. Accordingly, some embodiments of TCW may offer a richer set of functionalities and features and better performance than JTC in certain environments. For example, more screen views and UI features (e.g., charting, control of columns displayed) may be available in TCW than JTC. Embodiments of TCW may be tightly integrated with the WIN32 desktop applications. Accordingly TCW, as a native Win32 application, may perform better (i.e., faster user-interface interaction) when compared to JTC, which may require the processing interpreter, the Java Virtual Machine. Embodiments of JTC may provide a stand-alone Java application that runs without a browser.

Unlike embodiments of JTC, which operate as a stand-alone Java application, embodiments of TCW may operate as an ActiveX control hosted by an MS Internet browser or a plug-in hosted by Netscape browser. Embodiments of TCW may function as a browser-based application while embodiments of JTC run as a stand-alone application, outside of the browser. Embodiments of the TCW may be deployed as a browser (e.g., Netscape) plug-in and not as an ActiveX control.

Embodiments of the TCW are recommended over JTC when customers consider deploying a thin client on the Windows platform. TCW may have a rich set of functionalities in comparison to other thin client choices, and TCW offers good user interaction and performance. Embodiments of the JTC are recommended for deploying thin clients on non-Windows platforms.

Embodiments of the TCW may run on 32-bit Windows platforms—Windows 95, 98 and NT 4.0 and operates as an ActiveX control within the Microsoft Internet Explorer 4.x/5.x or as a Netscape plug-in in Netscape Navigator 4.x. Embodiments of the JTC may run on Solaris 2.6 as a stand-alone client application, for example. In addition, platform support may include Mac OS and other flavors of UNIX platforms. Embodiments of the Siebel Object Manager (“SOM”), as part of the Siebel Enterprise Server, are available on Windows NT 4.0 and Solaris 2.6, for example.

According to one embodiment, the installed Thin Client for Windows files (mostly DLL files) consist of dynamic linked libraries, required for the presentation of the TCW UI layer, will occupy about 7.5 MB of local disk space. The required CPU memory needed to operate the browser would suffice. An Internet browser typically takes only 2 MB of RAM.

According to one embodiment, the installed Java Thin Client files consist of Java archived files, Java runtime environment (i.e. JVM), UI gif files, and Java Thin Client executable which take up about 15 MB of disk space on the Solaris platform.

The required client CPU RAM memory is about 20-25 MB, according to an embodiment of the invention. The JTC itself uses only 7 MB while Java Virtual Machine uses the rest. An embodiment of the JTC uses JVM 1.1.7B and Swing library (Java Foundation Library). Other embodiments of the JTC may use JVM 2.0.

Server requirements for embodiments of TCW or JTC are highly dependent on the deployment environment and end user usage (i.e., Think Time—the idle time between user interaction with the application).

In addressing the server performance topic, a skilled artisan should note that the following figures are sample data and merely provide a rough guideline. Customers ultimately will need to tune their deployment configurations to maximize the capabilities of their servers. The following represents merely a sample benchmark (UNIX SOM):

Hardware configuration:

UNIX Siebel Object Manager running on a 4 CPU (336 MHz Sparc) Sun E3500 server with 3 GB RAM

Benchmark Results:

600 is the typical number of Thin Client users per instance of Siebel Object Manager server

3 MB memory is used per user/thread.

Additional SOM servers are needed to scale higher numbers of users.

For example, 6,000 users will mandate at least 10 servers (e.g., 4 CPU Dell Server with 2 GB of RAM or 4 CPU Sun E3500 server). Again, these figures are merely guidelines, and the TCW and JTC may be utilized in different configurations and configurations in which the same number of users are supported by either more or fewer servers.

The TCW and JTC are designed to operate within an enterprise intranet of reasonable high-bandwidth network. The bandwidth dependence rests primarily on the user's performance requirements. In some embodiments, at least a 128 KB network bandwidth (e.g., ISDN line) should be used to operate the TCW or JTC applications. This should ensure comparable user interaction results as a conventional Connected client. Note that whenever a large amount of data is transferred over a bandwidth-limited network, one may observe degraded performance of the TCW or JTC applications.

Since embodiments of TCW and the JTC are a true thin clients, only the user interface layer sits on the desktop/laptop in many embodiments. To work on remote laptops, TCW and JTC may also include the application(s)' business logic (e.g., in the form of Business Objects—Object Manager and Data Manager) as well as a local database, somewhat violating the basic premise of “thinness.” For users who need to operate in disconnected fashion, the Siebel Mobile client will serve all their requirements. Architecturally, however, the TCW or JTC comprises the same code that runs the user interface of the Siebel mobile client.

Additionally, in some embodiments, a single tool set may be used to customize both the client/server and the corresponding TCW or JTC. For example, Siebel Tools may be used to customize Business Components/Objects as well as the user interface of the TCW or JTC. Some embodiments of the TCW or JTC may even use the same Siebel repository file as a conventional Connected Client. For example, an srf file only needs to be placed on a SOM to be accessible to all JTCs connected to the Object Manager. There is no need to distribute the file out to each user separately. The very same files used for Siebel Mobile and Connected Client deployments can also be used for TCW or JTC.

The TCW and JTC may handle situations where the configuration calls for screens or features not supported in the TCW or JTC. Embodiments of the TCW and JTC may be configured to prevent users from accessing views that are based on unsupported applet classes. In such situations, developers have options such as:

1. Do nothing—the applet view will continue to be invisible to TCW and JTC users.

2. Replace the unsupported applet with a supported applet class that is similar in functionality.

3. Remove the unsupported applet and enlarge the remaining applets to fill the same space.

Of course, TCW and JTC may have many supported applet classes.

Embodiments of TCW and JTC may be deployed to thousands of end users by:

1. Setting up an embodiment of TCW or JTC Home Page containing links to the respective TCW or JTC login and the install executable.

a. For Internet Explorer 4.x/5.x browser, make link to a tclient.htm file.

b. For Netscape 4.x browser, make link to the tclient.stc file.

c. For the install executable, make link to the setup.exe file of the installed directory.

2. Editing the tclient.htm or tclient.stc to specify items such as a Siebel Gateway Server, Siebel Enterprise Server, SOM, and Siebel Server (if Resonate Central Dispatch—load-balancing manager—is not used).

3. Instructing users first that they have the TCW or JTC files installed on their local drive. For example, click on the “Install the Java Thin Client” link to invoke the installer.

4. Once the TWC or JTC files are installed, users can click on the Login link (or straight to the Login URL) to logon the TCW or JTC application.

Embodiments of the TCW and JTC provide robust security for enterprise applications in at least two distinct ways:

1. Data visibility rules of Enterprise Applications may be fully enforced. Accordingly, users can only see the data and Business Objects that their roles and responsibilities will support.

2. User names and passwords may not be saved on the users' desktops—authentication is conducted on the server side of the application. No risk of unauthorized access to the application by reading the information stored on a user's desktop exists.

Additionally, for embodiments of the TCW, packets sent between the SOM and the TCW may be encrypted using 40-bit to 128-bit RSA-standard encryption (as embedded in Microsoft's Crypto API).

In some embodiments, customers may provide access to users outside the enterprise firewall by:

1. Exposing a gateway server's (i.e., Siebel Gateway Server's) virtual or physical IP address (preferably VIP) and port.

2. Exposing an Enterprise Server's Virtual IP address (“VIP”) if Resonate Central Dispatch is used.

3. Exposing the IP address of every server (i.e., Siebel Server) machine through the firewall if Resonate Central Dispatch is NOT used.

4. Exposing every session-mode Siebel Server Component's port (e.g., ObjMgr, SSCObjMgr, etc.)

Additionally, the SOM may respond only to SISNAPI requests made by authenticated users. Users have access only to the Object Manager process and no other processes on that physical machine.

Embodiments of the TCW and the JTC communicate with the SOM using the Siebel Internet Session API protocol, SISNAPI. SISNAPI may be implemented as a very thin layer on top of TCP/IP, efficiently transferring references and data between the Object Manager and the JTC.

When compared to a conventional Connected Client, the performance of the TCW is comparable under most circumstances. Embodiments of the JTC may be slower due to the middle layer Java Virtual Machine interpreting the Java byte codes. In a preferred embodiment, TCW and JTC may be deployed over at least a WAN with 128 KB network bandwidth.

A conventional Connected Client makes SQL calls to the database server while TCW and JTC make business-object level requests to the SOM. The TCW and JTC architecture may take the following additional measures to ensure higher performance:

1. Calls between the TCW and JTC and SOM are at a sufficiently high level of abstraction (Business Objects) to minimize network roundtrips. This minimizes the impact of high-latency networks on the user experience.

2. Data returned from queries to Business Objects are cached by either the TCW or JTC to allow users to view multiple records without making a network roundtrip from each additional record.

3. Data between the TCW and JTC and SOM can be compressed.

While the invention has been described with respect to certain preferred embodiments and exemplifications, it is not intended to limit the scope of protection thereby, but solely by the claims appended hereto.

### APPENDIX

### Additional Detailed Description Regarding an Embodiment of the Invention

The following text provides a detailed description of an embodiment of the invention. A skilled artisan will recognize that the invention may be practiced in embodiments other than those disclosed herein. The described embodiment makes reference to elements developed by Siebel Systems, Inc. A skilled artisan will additionally recognize that the invention may be practiced without necessarily using elements developed by Siebel Systems.

Siebel Server Architecture

Enterprise Applications may built on an advanced, Web-based server architecture that provides a wide variety of features for deploying and supporting heterogeneous users enterprise-wide. Embodiments of the Siebel Server architecture exploit the configure once, deploy everywhere capabilities of Siebel's n-tiered software model.

Architecture Requirements for Front Office Deployments

Embodiments of the Siebel Server architecture have been designed to meet the requirements of comprehensive front office deployments in the largest global sales, marketing, and customer service organizations. These requirements include:

Configure Once, Deploy Everywhere Capabilities.

Supports the entire front office application from a single set of objects and a common business logic.

Support for Heterogeneous Users.

Supports thick, thin, mobile, Personal Digital Assistant (PDA)-based, and custom clients operating across multitiered sales, distribution, and service channels both inside and outside the enterprise.

A Web-based Architecture.

Takes full advantage of the efficiencies and opportunities for extended application access and functionality provided by the Internet.

A Robust Middle Tier.

Provides flexible and scalable support for three-tiered client/server operation, workflow and process automation, and other batch- and volume-oriented processes.

Flexible and Scalable Data Access.

Includes complete data synchronization and replication capabilities to make all front office data, whether physical files or database records, seamlessly and transparently available to users across the enterprise.

Comprehensive Enterprise Interfaces.

Supports functional, high performance, and maintainable integration with other enterprise applications.

Enterprise Class Performance, Scalability, and Availability.

Supports from tens to hundreds of thousands of users operating in demanding, high-volume, 240 environments.

Siebel Server Architecture Overview

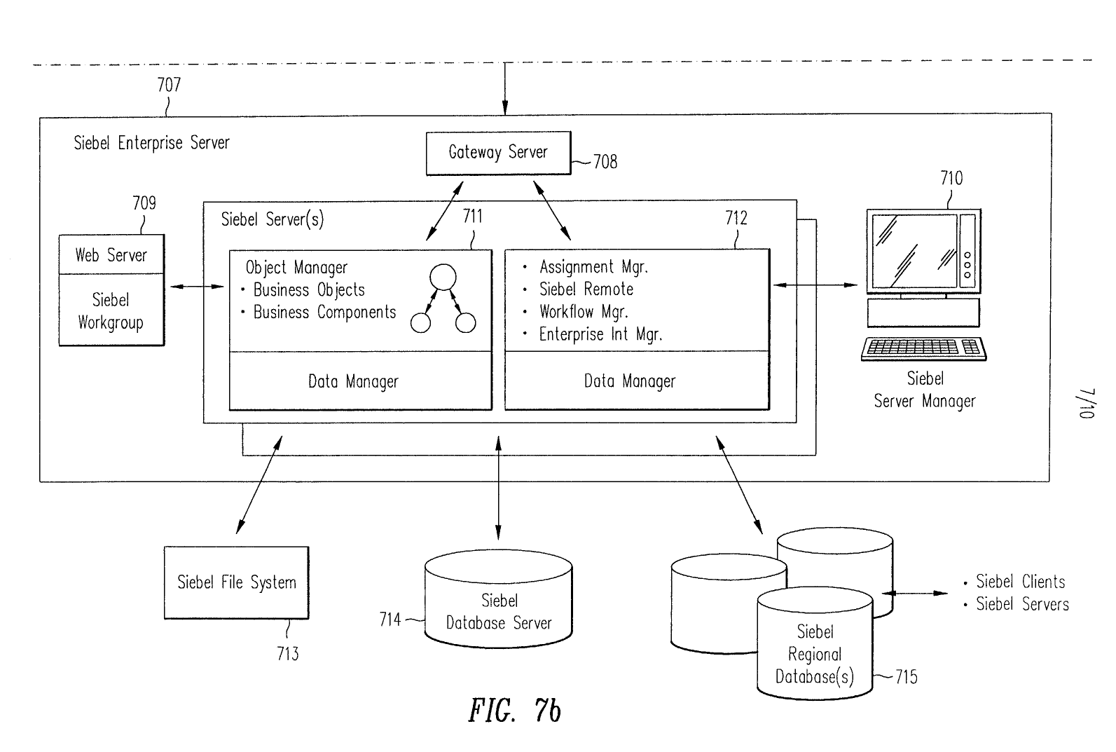

FIG. 7 illustrates software components comprising the Siebel Server architecture, according to an embodiment of the invention. The server architecture follows the common three-tiered client/server model that divides the three layers according to function:

Clients including the HTML and thin clients, mobile clients, and connected clients

The middle tier enterprise server which includes the Siebel Server, Gateway Server, and Server Manager components

Data storage in the Siebel Database Server and Siebel File System

Configure Once, Deploy Everywhere

Siebel Enterprise Applications may be built on a multitiered product architecture. Enterprise Applications may include a prebuilt set of data schema entities and relationships, Siebel business objects, data presentation applets, and other application components. A common set of base classes, developed in C++, ensures consistent and reusable behavior across all Siebel applications and components. Siebel components may be designed based on industry best practices, defined as objects in the Siebel Repository, and dynamically instantiated at run time based on the base set of classes and data-driven object definitions. These objects can be deployed across multiple tiers of the Siebel Server architecture to provide application access and functionality to heterogeneous users across all channels including the Internet, intranets, extranets, local area networks (“LANs”), and wide area networks (“WANs”).

In some embodiments, prebuilt run-time engines operate these objects; each executable instantiates the required business objects, applets, and other application objects as needed and enforces the repository-defined business processes and rules. The run-time engines provide complete flexibility in determining which application objects execute in which layers of the deployment architecture and how they are operated, enabling customers complete flexibility in providing multiple classes of users access to Siebel Enterprise Applications. For example, some Clients may execute all application objects locally and communicate directly with the Siebel Database Server, whereas other clients execute only the user interface objects locally, interacting with a multithreaded engine operating business objects in the middle tier Enterprise Server. This same business object engine can be accessed through industry-standard Component Object Model (“COM”) and Common Object Request Broker Architecture (“CORBA”) interfaces, allowing other applications to interface in real time with Siebel Enterprise Applications.

Siebel's configure once, deploy everywhere technology enables customers to support multiple client computing platforms and configurations easily and cost effectively, a critical requirement in comprehensive front office deployments, without having to master or maintain multiple code bases and technology platforms. Many competing products with more limited or monolithic architectures provide only a single viable deployment option, a restriction that can seriously limit the scope of a front office deployment.

By providing prebuilt run time engines for executing application objects, this embodiment of the Siebel architecture isolates customers from the difficulties inherent in creating, testing, and supporting low-level application code that performs such functions as user interface display and database access. Such core application functionality is provided by proven, tested run time engines, greatly reducing the cost and risk of customer application configuration, which is then limited to customizing the base business rules and logic and user interfaces of the application.

In addition to major advantages in the initial implementation, Siebel architecture also provides one-button upgrade technology that transparently migrates customizations to future releases, providing customers a guaranteed upgrade path that maintains all their changes to Enterprise Applications.

Support for Heterogeneous Users

Embodiments of the Siebel architecture support multiple client types that operate varying classes of objects, such as Siebel Objects, providing different application models that effectively meet the requirements of heterogeneous users enterprise-wide.

Thin Clients.

Siebel architecture supports three types of lightweight clients based on Web technology: ActiveX, Java, and HTML versions of Siebel Thin Client. These clients share common business objects operating on a scalable middle tier server, while user interface objects operate within a standard Microsoft or Netscape Web browser without client-side software installation or maintenance.

Collectively, the various flavors of Siebel Thin Client enable customers to deploy maintenance-free clients to users within the enterprise, as well as to extend front office access to resellers, partners, customers, and other users outside the corporate intranet. They provide extended support for inter-organizational information sharing as well as for Internet-based commerce and self-service.

The business objects for the thin clients are operated by the Siebel Object Manager component, operated on Siebel's flexible and scalable middle tier application server, the Siebel Enterprise Server. ActiveX and Java Thin Clients connect directly to the Object Manager using efficient, session-based network protocols. The Siebel HTML Thin Client interacts with an industry-standard Web server that connects through the Siebel Web Engine to the Siebel Object Manager. The Siebel Object Manager provides on-demand instantiation of Siebel business objects and manages their life cycles.

Dedicated Clients.

The dedicated client may operate on 32-bit Windows client platforms. The dedicated client uses the same business objects as the thin clients operating in a locally resident Object Manager that communicates directly with the Siebel Database Server. The dedicated client also can call and make direct use of the Siebel Assignment Manager, Siebel Workflow Manager, Siebel List Manager, and other Siebel Server components operating in the Siebel Enterprise Server.

Mobile Clients.

Siebel software enables truly mobile computing by providing both local database and local file system capabilities to the dedicated client, allowing it to operate with full functionality while disconnected from the corporate network. Siebel Sales Enterprise and Siebel Field Service are commonly deployed on the laptop computers used by field-based sales and service professionals. Using Siebel Remote, Siebel's industry standard for mobile database synchronization, the mobile client may periodically connect to the Siebel Enterprise Server to synchronize database and file changes quickly with the central database server and file system.

Custom Clients.

The middle tier Siebel Object Manager that supports the Siebel Thin Client may also provide industry-standard COM and CORBA interfaces that provide access to all the Siebel business objects and a complete set of methods for manipulating them. These interfaces enable customers to provide full access from other client applications or through application interfaces to all the data and all the business logic in the Siebel Enterprise Applications through industry-standard object interface and object models.

Robust Middle Tier Platform

The Siebel Enterprise Server is the flexible and highly scalable middle tier of the Siebel Server architecture. The Siebel Enterprise Server comprises one or more Siebel Servers that execute a variety of programs, implemented as Siebel Server components, providing workflow and process automation, volume database interfaces, data synchronization and replication, and similar functionality to the Siebel Enterprise Applications.

Siebel Server components are designed to scale effectively across multiple processors in a single Siebel Server and across multiple Siebel Servers. The Siebel Administrator has complete flexibility over the distribution of server components across Siebel Servers within an enterprise.

The Siebel Enterprise Server parallel processing approach provides a high degree of scalability to meet the processing requirements of even the largest deployments, providing a clear advantage over the monolithic server model used by many other front office applications. The other front office applications concentrate processing on a single database server or application server, which will quickly be stressed beyond its fixed resources as the deployment grows. When the database server is used for processing it greatly increases contention for database resources between connected and mobile clients and batch processes.

The Siebel Enterprise Server may be configured, managed, and accessed as a single logical entity, regardless of the number or configuration of the underlying Siebel Servers. The Siebel Enterprise Server contains two entities that control access to and manage this logical entity: the Siebel Gateway Server and the Siebel Server Manager.

Siebel Gateway Server

The Siebel Gateway Server manages access to the Enterprise Server, acting as a single entry point, providing enhanced security, load balancing, and providing high availability. The Siebel Gateway Server incorporates two services: Siebel Name Server and connection brokering.

The Siebel Name Server provides the persistent store for the complete set of parameters that determine the configuration and operation of the entire Enterprise Server. Parameters are modified using the Siebel Server Manager, a graphical server management and monitoring desktop, and automatically are read by each Siebel Server at start-up time.

The Siebel Name Server may also provide a dynamic registry for Siebel Server and component availability information. When a Siebel Server is started, it notifies the Name Server of its availability and stores its connectivity information in the Name Server's non-persistent store. This availability and connectivity information is used by other components needing to connect to the Enterprise Server including the Server Manager and the Connection Broker.

Connection brokering works in conjunction with the Siebel Name Server to provide dynamic load balancing and fault tolerance. Siebel clients that need to access Enterprise Server components submit their connection requests to the Gateway Server, rather than to a specific Siebel Server. The Gateway Server then transparently directs the client request to the least laden Siebel Server within the enterprise that is operating the desired component.

Connection brokering helps ensure scalability by making the most efficient use of the computing resources in the Enterprise Server, and ensures high availability by eliminating Siebel Client dependencies on a specific Siebel Server. Client connection requests will be satisfied by any available Siebel Server executing the desired component, allowing unimpeded client operation even if a given Siebel Server has had a hardware failure or is taken offline for administration.

Siebel Server Manager

Embodiments of the Siebel Server Manager provide a single, unified tool for configuring, managing, and operating the entire Enterprise Server including all Siebel Servers and server components. By using either the command line or the graphical user interface of the Siebel Server Manager, the Siebel Administrator can set the parameters that control component operations quickly and easily; start. stop, pause, or resume component processes; and monitor the status and health of components operating on multiple Siebel Servers across the enterprise.

The Siebel Server Manager provides a multilevel view of the entire Enterprise Server. The Siebel Administrator can drill down from the Enterprise Server to lower-level views that focus on a single Siebel Server, server component, or component process. This multilevel view provides both an immediate big picture view of the entire Enterprise Server and the ability to drill into the operation of a specific Siebel Server or server component for monitoring or application tuning at increasingly fine levels of granularity.

The Siebel Server Manager maintains complete statistics and operating logs for each server component, and provides a comprehensive set of trace flags and diagnostic tools to enable the Siebel Administrator to drill into problematic operations in much greater detail.

Siebel Server

The Siebel Server provides an application server platform in the Siebel Enterprise Server. The applications that execute on the Siebel Server are implemented as components that share common control, administration, and monitoring functionality regardless of the different processes they execute. The Siebel Server supports a wide variety of components, executing in both multiprocess and multithreaded models. Some components interact directly with Siebel Clients; others are batch-oriented and interact only with the Siebel Database Server.

Siebel Enterprise Applications provide a complete suite of Siebel Server components that include:

Siebel Workflow Manager

Siebel Assignment Manager

Siebel Enterprise Integration Manager

Siebel Object Manager

Siebel Remote

Siebel Replication Manager

Flexible and Scalable Data Access

The Siebel Server architecture provides complete access to all front office data, whether that data consists of physical files stored on the Siebel File System or as records within the Siebel Database Server. Both data storage mechanisms are highly optimized for the specific datatypes and access requirements of front office applications.

A centrally located Siebel Database Server and Siebel File System are accessed by Siebel connected and thin clients and by the Siebel Enterprise Server components. Siebel Remote and Siebel Replication Manager can be implemented to synchronize local copies of the central database server and file system to laptop-based mobile users and satellite or regional offices, respectively, to extend data access to geographically distributed users across the enterprise.

The Siebel File System and Siebel Database Server are discussed in detail in the sections that follow.

Siebel File System

The Siebel File System 713 provides a network-based directory structure that stores all the physical files associated with records in the Siebel Database including Siebel Encyclopedia items, correspondence templates, file attachments, and other files. Siebel clients can access and retrieve files from the Siebel File System directly in the case of the Siebel Dedicated Client or through the Siebel Enterprise Server for remote or thin clients.

The Siebel File System provides comprehensive storage for the multitude of front office data not easily stored in a relational database. Any data that can be stored as a physical file-documents, email, images, scans, etc.—may be stored and made accessible to all Siebel users through the Siebel File System.

Siebel Database Server

The Siebel Database Server may be implemented using leading relational databases from IBM, Oracle, Microsoft, Sybase, and Informix, and store all the application data for Siebel Enterprise Applications. The Siebel Database Server provides a complete data model out-of-the-box, and is accessed through a highly optimized Data Manager layer from both Siebel Clients and the Siebel Enterprise Server. The data model can be extended and configured, using Siebel Tools, to ensure the Siebel Database Server's ability to meet the data storage and access requirements of users across the enterprise.

Data Manager Layer

Both Siebel Clients and Siebel Enterprise Server components access the Siebel Database Server through a common Data Manager layer. The Data Manager may provide a connector specific to each of the relational databases supported by Siebel Enterprise Applications. This database connector may be highly optimized, typically through joint engineering efforts with the database vendors, to ensure the best possible performance and scalability from each database, as well as to reduce network bandwidth consumption and round trips. The Data Manager uses each vendor's native interface and specific Structured Query Language (“SQL”) syntax and implementation features.

Examples of both general and vendor-specific performance features of the Data Manager include:

Optimizer Hints.

Optimizer hints or directives can be included in SQL statements created by the Data Manager to ensure efficient execution.

Cursor Modes.

The database connector can set the specific cursor modes and isolation states as appropriate for specific operations to optimize use of the database's data cache and concurrency controls without excessive lock overhead or contention.

Bind Variables.

Bind variables are used extensively in the SQL statements that the Data Manager creates dynamically. When bind variables are used, a SQL statement is sent to the database only when first executed, as in the first time that a Siebel user enters the Account List view. Subsequent execution of the SQL statement by that user, for example to require the same view for another account number, sends only the new bind variables to the database. This can greatly reduce the amount of SQL being sent across the network.

Multiple SQL Operations.

The Data Manager can group multiple SQL operations into a single call to the database, using such features as deferred network calls, various types of joins, and dynamically generated procedural (or transactional) SQL. Using these techniques, the Data Manager may populate most screens in the out-of-the-box Siebel Enterprise Applications with only a single round trip to the Database Server. Operations such as “Deletes,” that affect multiple rows similarly, can be sent to the Database Server as a single statement, rather than a statement per affected row.

Database Cursors.

Rather than simply return all rows from each query directly to the Siebel Client, the Data Manager makes extensive use of database cursors as a holding or staging area. Once the SQL statement has executed, the Data Manager retrieves a limited number of rows from the cursor, typically enough rows to populate the current view plus a small buffer to allow scrolling through the records. Additional sets of records then are fetched from the cursor if required by user operations.

The Data Manager implements client-side denormalization mechanisms, including mechanisms to collapse many-to-many into one-to-many relationships, and denormalizes user keys into specific data structures predefined in the Siebel Data Model. As a result of such optimizations, Siebel Enterprise Applications exhibit exceptional performance for searches and sorts against very large databases.

In addition to optimizing database access, the Data Manager also provides further support for Siebel's configure once, deploy everywhere capabilities. The Data Manager is an abstraction layer that isolates all objects in the higher application layers, including business objects and user interface applets, from the characteristics of the underlying datastore. All higher level objects are completely database independent. allowing them to operate against different relational databases simply by specifying a different database connector at start-up time.

This database independence provides maximum flexibility in deploying clients. For example, the same application configuration can be used against a central Siebel Database Server as both a Siebel Dedicated or Thin Client and against a local database for a Siebel Mobile Client. Users of the dedicated client may operate directly connected to the Database Server in one session and choose to operate against the local database in the next.

Siebel Data Model

The Siebel Database Server uses a comprehensive, highly evolved data model comprising more than 1,200 tables in the Siebel 99 product family. Unlike other front office applications that provide only a simplified, skeletal data model a fraction of this size, Siebel Enterprise Applications provide a fully functional data model designed to meet the requirements of complex front office deployments out-of-the-box. The data model also can be extended easily and be customized using Siebel Tools.

The objectives of the Siebel Data Model design are:

To Create a Rich Information Model to Meet Cross-industry Requirements.

Siebel Systems delivers the most comprehensive customer-centric information data model for sales, marketing, and customer service that takes into account the requirements of a broad range of industries including consumer packaged goods, financial services, insurance, electronics, telecommunications, and high technology.

To Develop a Superior Strategy for Integration with Other Corporate Systems.

Siebel Enterprise Applications support a number of integration approaches including synchronous and asynchronous application programming interfaces (API) that provide support for business functions across Siebel Enterprise Applications and other enterprise applications such as accounting, manufacturing, and human resources.

To Create a Flexible Architecture to Allow for Database Extensions.

Siebel Enterprise Applications deliver a comprehensive front office data model that can be fully customized to fit specific customer business requirements. The Siebel Enterprise Applications architecture enables users to make these customizations while preserving their ability to upgrade to future product releases and support these customizations across all Siebel Enterprise Applications modules.

To Provide Rich, Seamless Support for Internationalization.

The Siebel data model has built-in support for internationalization features such as multiple currencies, including the Euro, and multiple languages.

To Ensure High Performance Database Design.

The Siebel data model supports complex business functionality without sacrificing application performance. Siebel Enterprise Applications have been designed and proven to operate extremely efficiently against very large databases with large numbers of users.

Data Model Development

The Siebel Data Model was developed using a structured methodology and state-of-the-art, computer-aided software engineering (“CASE”) development tools. The Siebel Data Model is composed of major entities, association entities, relationships, primary and foreign keys, and other information, such as cluster keys, required to instantiate the physical data structures. It has been designed to be very flexible and to optimize performance for both users as well as server processes.

The Siebel Data Model enables the end user's business environment to dictate the data requirements, not the data model itself. Poor modeling designs often require users to supply specific data to create a record, even when that data is unimportant to the business. The Siebel Data Model is designed to allow the business to decide what data elements are required, with the unused elements simply left blank. For example, to create a new contact, some systems require a valid telephone number. Siebel Enterprise Applications allow telephone numbers, but also enable users to create contacts without supplying a telephone number.

Siebel Enterprise Applications also provide unconstrained flexibility for extending and customizing the data model. Each of the major entities in the data model contains extra attributes that can be used for specific data requirements. In addition, users can activate extensions to major entities that allow additional data to be stored and maintained with the main record. These extensions are managed automatically by the application as if they were a part of the main table.

With the Siebel Database Extension Designer, developers can extend the data model in their own specific ways by adding extension tables and columns to contain exactly the desired elements.

Although the Siebel Data Model has a number of provisions for extension, it already has at its core all the major data entities required for a global sales, marketing, and service enterprise. The data model includes a very large number of entities. Following is a small sample.

Opportunity Management.

Entities related to an opportunity (or lead) including relationships to contacts, employees (generally sales or service representatives), products, accounts, activities, and sales cycles.

Products/Product Lines.

Entities related to a product include product components (product structure), substitute or competitive products (product comparison), the product's vendor, and the product line(s) to which the product belongs. Additionally, the Siebel Data Model captures the relationship between products and product prices.

Forecasts.

Siebel Data Model supports forecasting by opportunity, product. products on opportunities, and accounts. Individual sales representatives or managers can submit a forecast, and a forecast may be based on other forecasts—such as a manager who rolls up the forecasts of all reporting sales representatives.

Employee/Position.

Entities that describe the structure of the internal organization unit (selling/servicing company) are composed of the positions in the organization unit and the assignment of employees to these positions. The entities also define the position's responsibilities for territories, product lines, service requests, and opportunities.

Campaign.

Campaigns or marketing programs may be composed of subcampaigns. The campaign may be the source of one or more leads, and may leverage one or more call lists to generate those leads.

Service Request.

Entities related to service requests and service request actions are handled as a series of activities, each owned by a specific employee. Relevant information includes the contact who reported the service request, the product with which assistance is requested, the customer's environment or profile, and which third-party products are in use and relevant to the service request.

Product Defect Tracking.

Defects can be associated with service requests and may have associated activities defined to fix the defect. Associations may be defined with various product versions to record which are affected by the defect, which are planned to fix the defect, and which actually fix the defect. Additional relevant associations with external products may be recorded. Defects may be associated with other related defects.

Assets.

These encompass entities related to product inventories, products purchased by an account, or products held by a contact. These assets may be the subject of sales documents (such as quotes or contracts), service requests, activities, and others. An asset may be a personal or corporate account (such as financial accounts or insurance policies).

Sales Documents.

Entities in the area of sales documents include:

Quotes for an account including products referred to in the quote, price list, and payment terms

Agreements for an account including service and pricing agreements

Correspondence sent to account contacts

Orders processed for an account

Data Modeling Methodology

A top-down structured development methodology includes defining business Functions and modeling information. The result is a high quality product that meets market requirements.

Siebel Enterprise Applications are developed using a computer-aided software engineering (CASE) methodology. The CASE methodology provides Siebel Systems with design and development guidelines at each stage of the application development life cycle. The process for developing Siebel Enterprise Applications includes the following major steps:

Identify the Business Functions the Application Needs to Support.

Identify functional requirements in the form of market requirement documents that accompany each application component.

Model Information.

Identify entities, or business objects, of significance to the application and the relationship among these entities. This analysis also identifies the attributes of the entities.

Design the Physical Database.

Define the required database tables, columns, and indexes. Significant attention is paid to producing a physical model that meets the performance requirements as well as the complex business needs of the application.

Conduct Quality Cross-checks.

Employ quality assurance cross-checks at each phase of the development life cycle to ensure that design issues are identified early in the development process. Examples of such cross-checks include verification of entities used by business functions.

Data Model Extensions

Because no two enterprises are identical, Siebel Enterprise Applications provide customers complete flexibility to extend the data model to accommodate specific customer requirements. Customer application developers can add columns to existing Siebel database tables, add additional tables and indexes, and expose and map these tables for database-level interfaces.

As with all other customizations to Siebel Enterprise Applications, data model extensions are performed using Siebel Tools to change the definitions of the logical database schema stored in the Siebel Repository. Additional technology then applies these modifications either directly into the underlying database or into a Siebel Anywhere Upgrade Kit that distributes and applies the changes across replicated and mobile databases.

Maintaining the data model schema in the Siebel Repository has three major benefits:

It makes the data model an integral part of an application configuration, ensuring that all extensions are included when the application configuration is moved from the development to the test or production environments.

It ensures that customer extensions automatically are migrated forward when upgrading to later releases of Siebel software using the Application Upgrader.

The Data Manager layer used by all Siebel programs automatically generates the SQL required for database access from the logical database schema, obviating the need for Siebel application developers to write, maintain, and tune the often complex SQL statements.

Comprehensive Application Interfaces

The ability to integrate seamless and transparently with other enterprise applications is one of the most critical success factors of front office deployments. Siebel Enterprise Applications provide a complete set of standards-compliant interfaces through Siebel Enterprise Interfaces. Siebel Enterprise Interfaces provide both transactional and volume-oriented interfaces that provide access to all the business data and all the business logic within Siebel Enterprise Applications.

Transactional Interfaces

Siebel Business Objects, which contain the business logic and data for Siebel Enterprise Applications, can be accessed by external applications as both Microsoft COM and OMG CORBA-compliant objects. The Business Object Interfaces can be accessed from both the Siebel Dedicated or Mobile Clients and from the Object Manager component on the Siebel Enterprise Server, enabling online integration from the client and server side.

The Business Object Interfaces provide a complete set of methods for manipulating the objects, providing unprecedented flexibility in application integration across all vertical industries—including the telecommunications, financial services, and pharmaceutical industries—where both of these standards have captured mindshare as ways to unify the entire enterprise.

Volume-oriented Interfaces

The Enterprise Integration Manager component of the Siebel Enterprise Server is a complete, high performance solution for interfacing large volumes of data directly with the Siebel Database Server. Enterprise Integration Manager (“EIM”) uses a set of predefined interface tables as the integration point for external applications which need deal only with the simple, highly denormalized structures of these interface tables.

At run time, EIM reads the structures of both the interface tables and the base application tables from the Siebel Repository, along with the mappings that join them together, and dynamically generates the SQL statements needed to perform import, update, export, delete, or merge operations. EIM uses a simple input file to control the operations executed in a given run. This file can specify a broad import that will populate a new Siebel Database Server with all the data needed to run Siebel Enterprise Applications, or can execute processes as refined as updating only a single column in a given table.

EIM uses the Data Manager layer and specialized set-based processing techniques to ensure the performance needed to manipulate millions of rows of data at a time. Operation status is recorded at the row level, providing the Siebel Administrator complete monitoring of EIM processes and the ability to repair and reprocess problematic rows.

Interface tables, base tables, and mappings used by EIM are fully customizable using Siebel Tools. This enables customers to construct interfaces that use newly created tables and columns easily. As with all Siebel Repository objects, these definitions are automatically upgraded to new releases of the Siebel Enterprise Applications, minimizing the maintenance requirements for EIM interfaces.

Prebuilt Interfaces

The Siebel architecture supports prebuilt interfaces between Siebel applications and accounting, manufacturing, distribution, human resources, and product configuration applications. These prebuilt interfaces enable rapid application deployment and reduce overall application maintenance.

Enterprise Class Scalability and Performance

Siebel System Software was design to ensure unprecedented scalability and overall performance to enable immediate access to information and enforce timely collaboration. The software supports configuration of thousands or tens of thousands of concurrent and mobile users and very large databases and datamarts. This is achieved through combinations of the following features:

Scalable Midtier.

The Siebel Enterprise Server can be deployed across multiple Siebel Servers on multiple (hardware) servers for high scalability. The Gateway Server provides for optimized allocation of requests across servers.

Fast Data Synchronization.

Siebel's unique technology enables fast and timely synchronization of very large numbers of mobile users with a central site. The same technology supports configuration of a hierarchical system consisting of multiple regional systems, each maintaining synchronization with a corporate site. Such configuration multiplies overall throughput while still operating as a single integrated environment.

Fast Response Time Over the LAN, WAN, Dial-up, and Internet.

Siebel technology minimizes network traffic between the thin client and the Object Manager, mobile clients and the Siebel Remote Server, and dedicated clients and the Siebel Database Server. This ensures enhanced response time for all clients across low bandwidth, high latency channels.

High Throughput Interfaces.

Siebel EIM enables the transfer of very large volumes of data. The EIM Server is scalable through replication.

Very Large Database Support.

Siebel generates highly optimized SQL statements tuned to each database environment. In addition, the data synchronization technology enables effective partitioning of the data across multiple databases.

Table 1 discusses features of an embodiment of the Sieble Server architecture.

TABLE 1
Siebel Server Architecture Features

| | | | |
|---|---|---|---|
| ✓ | GENERAL | | |
| | ARCHITECTURE | | |
| | CHARACTERISTICS | | |
| | | ✓ | Central, consistent object repository |
| | | ✓ | Simultaneous support for multiple |
| | | | deployment strategies |
| | | ✓ | Scalable, n-tiered architecture |
| | | ✓ | Comprehensive enterprise interfaces |
| | | ✓ | Enterprise class scalability, |
| | | | performance, and availability |
| | | ✓ | Dynamic load balancing |
| | | ✓ | Simplified system administration |
| | | ✓ | Dynamic process monitoring and |
| | | | adjustments |
| | | ✓ | Reusable business object tier accessible |
| | | | by all Siebel and third-party |
| | | | applications |
| | | ✓ | COM and CORBA interfaces |
| | | ✓ | One-button object upgrades |
| | | ✓ | Supports Windows, Java, and |
| | | | HTML thin clients |
| | | ✓ | Supports mobile client synchronization |
| | | ✓ | Parallel process architecture for |
| | | | maximum scalability |
| | | ✓ | Provides connection brokering |
| | | ✓ | Graphical server management and |
| | | | monitoring |
| | | ✓ | Dynamic registration services |
| | | ✓ | Comprehensive statistics and process |
| | | | logging |
| | | ✓ | Bi-directional, high-volume data |
| | | | transfer processing |
| ✓ | DATA | | |
| | MANAGEMENT | | |
| | LAYER | | |
| | | ✓ | Support for optimizer hints for |
| | | | maximum performance |
| | | ✓ | Support for cursor modes to optimize |
| | | | data cache and concurrency |
| | | ✓ | Support for reusable bind variables |
| | | ✓ | Support for grouped SOL operations |
| | | ✓ | Database cursor support for effective |
| | | | use of set-based retrieval |
| | | ✓ | Siebel Server Architecture |
| ✓ | DATA MODEL | | |
| | | ✓ | Comprehensive model comprised of |
| | | | more than 1200 tables |
| | | ✓ | Cross-industry data model |
| | | ✓ | Flexible, extensible design |
| | | ✓ | Built-in support for global deployment |
| | | ✓ | High-performance design for effective |
| | | | processing of very large databases |
| | | | and numbers of users |
| | | ✓ | Prebuilt data extensions |

Siebel Internet Architecture

The World Wide Web has changed the rules for creating and deploying enterprise applications. Siebel Systems' architecture exploits the benefits of the Web by making available the Siebel Thin Client—a true thin client technology for deploying Siebel's sales, marketing, and customer service applications to users with Web browsers and no previously installed client-side software.

The Siebel Thin Client architecture gives enterprises:

Dramatically reduced total costs of ownership for all their Siebel applications.

A platform for deploying mission critical front office and electronic commerce applications throughout the extended enterprise.

The ability to configure Siebel applications once and then deploy them in the manner best suited to users—to mobile laptops or handhelds in the field, thin clients in the call center, or to the corporate Web site for strategic partners or end customers.

Support for all leading Internet user interface technologies: Java, HTML, and ActiveX. Enterprises can select from the Siebel Java Thin Client, Siebel Thin Client for Windows, and the Siebel HTML Thin Client to deliver the type of thin client that best meets user requirements.

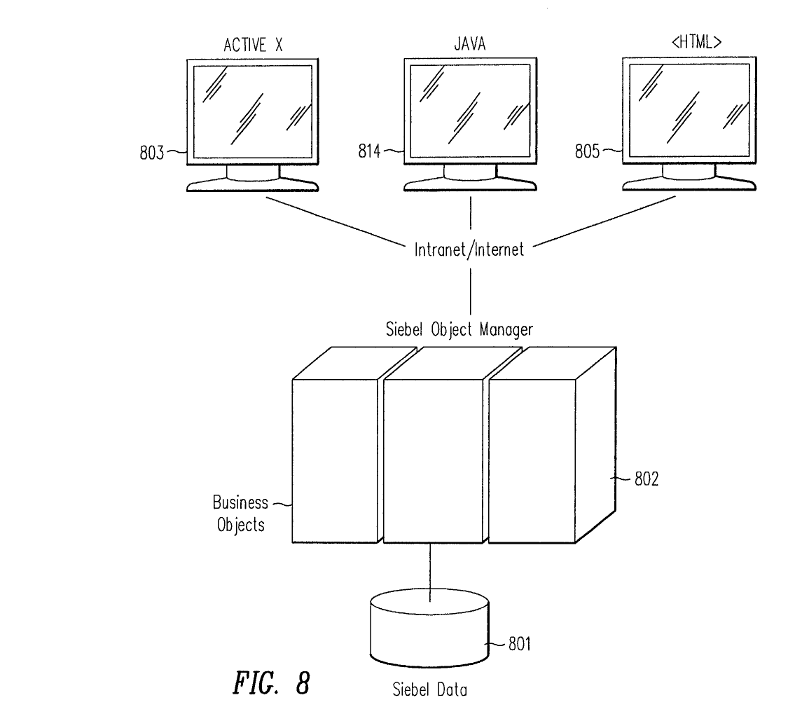

FIG. 8 illustrates a Siebel Thin Client-support for leading Internet standards, according to an embodiment of the invention.

Moreover, enterprises make no sacrifices to achieve these benefits:

The Siebel Thin Client for Windows and the Siebel Java Thin Client user interface is the same intuitive, highly interactive graphical user interface available across the Siebel Enterprise Applications suite, in mobile and connected form.

The Siebel HTML Thin Client supports the look and feel of the enterprise Web site, seamlessly integrating Siebel's increasing range of eBusiness applications with the enterprise extranet.

Lower Cost of Ownership

With the Web, enterprises can have the best of two previous generations of computing: the graphical interfaces pioneered by personal computers and the highly cost efficient architectures of centralized, mainframe-based applications. But although they recognize the shift and the need to “Web-enable” their products, many enterprise application vendors have been trapped in outdated, monolithic application architectures, unable to take advantage of the new paradigm.

With Siebel Thin Client architecture, enterprises can deploy the world's leading front office system through the Web browser, taking advantage of the entirely Web-based Siebel n-tiered architecture. No longer do information technology (IT) organizations need to install software in remote field locations or upgrade thousands of older generation PCs to support the needs of a richly featured, modem enterprise application. Users can access the application as long as they have a Web browser and know how to reach the enterprise intranet.

Instead of consuming costly desktop computing cycles or memory, browser-based thin client applications such as Siebel Sales Enterprise, Siebel Service Enterprise, or Siebel Call Center can execute on shared servers where computing resources can be pooled for maximum efficiency across all the users in the enterprise. And instead of upgrading each desktop with every new release of software, enterprises can deploy upgrades once to the server where they immediately become available to all connected thin client users.

Platform for Siebel eBusiness Applications

With Thin Client architecture, Siebel's market-leading sales, marketing, and customer service solutions can reach beyond the enterprise's own employees into the extended enterprise of partners, resellers, and end customers.

Siebel Thin Client Architecture is the platform for Siebel eBusiness Applications, a comprehensive suite of compelling, scalable, and secure Web-based applications.

Siebel eBusiness includes:

Siebel eSales.

A comprehensive Web-based application to support unassisted business to business and business to consumer selling over the Web. Siebel eSales includes a visual product catalog, Web-based quote generation, solution configuration, and online ordering. By integrating Siebel eSales with existing Web sites, Siebel customers quickly can set up shop on the Internet, leveraging product data, marketing collateral, and configurations across their multiple selling channels—the field, call center, indirect, and Web.

Siebel eService.

Allows organizations to provide exceptional customer service and support through the Internet. Siebel eService provides Web-based and email-based service automation to manage the entire service process, allowing customers to easily create new service requests, enter service details, locate and track progress of open service requests, and view solutions. eService also proactively notifies customers of important events via email, both acknowledging receipt of the service request and informing the customer of an update or resolution.

Siebel eChannel.

A Web-based software suite that allows enterprises to turn channel partners into an extended, virtual sales and service organization. Siebel eChannel allows organizations to route leads, sales opportunities, and service requests to the appropriate channel using configurable business rules and track their performance on all assigned items. Siebel eChannel enables channel partners to browse product and pricing information, create solutions, and generate quotes and orders online, automating the entire partner and vendor relationship. Through all interactions, sophisticated security rules ensure that partners and vendors are able to keep sensitive information completely confidential.

Siebel eMarketing.

Provides organizations with the automation tools to rapidly, create, execute, and assess the effectiveness of Web-based marketing campaigns. With Siebel eMarketing, enterprises can segment their customer and prospect bases, target them with an automatically generated Web or email-based communication or promotion, and assess the effectiveness and return on investment of the campaign online through a set of OLAP-based analytical views and reports.

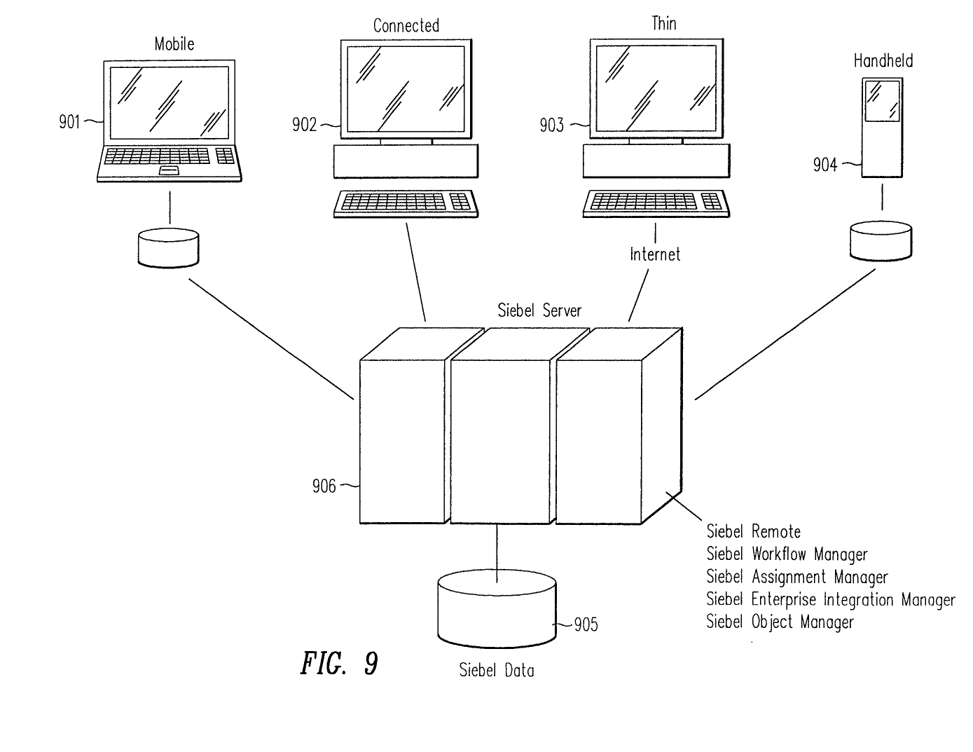

FIG. 9 illustrates a Siebel Thin Client and the Siebel n-tiered architecture, according to an embodiment of the invention.

Configure Once, Deploy Everywhere

Applications such as Siebel Sales Enterprise, Siebel Service Enterprise, and Siebel eService, or Siebel eChannel all can be configured through Siebel's single graphical configuration environment, Siebel Tools. Customers can deploy their configured applications to their mobile users working from the Siebel Mobile Client and to their thin client users working from a Web browser.

Siebel eService is built on the HTML Thin Client architecture, with functionality to support the needs of end users requesting self-service.

Siebel supports all leading thin client technologies-ActiveX, Java, and HTML-to ensure that browser-based users can access Siebel applications across a wide range of desktop platforms and connection speeds to the Internet.

Fully Interactive Interface-Siebel Thin Client for Windows and the Siebel Java Thin Client

For enterprise users, Siebel Thin Client for Windows makes available highly interactive Windows- and Java-based user interfaces that avoid the limitations of HTML's page-based processing. Instead of clicking on a Submit button and waiting for approval from a sessionless Web server, for example, Siebel Thin Client for Windows and Java Thin Client users can benefit from immediate responses to any data they enter. The thin client already is connected to a live session on the server, and the user interface applies field-level validation whenever the user presses the Tab key on the keyboard.

Siebel Thin Client for Windows and Java Thin Client offer the same user interface available to all Siebel mobile users today—a Web browser-based user interface built on years of experience with the most demanding field and call center-based enterprise users.

Siebel Thin Client Architecture Components

Siebel Thin Client for Windows

Siebel Thin Client for Windows is designed to support the enterprise's Windows-based users with a high performance user interface. The Windows version of Siebel Thin Client looks and works like the Siebel connected or mobile client, allowing users already familiar with the Siebel user interface to access Siebel applications through a standard Microsoft or Netscape Web browser without having to install any software on their desktops. For the enterprise IT department, this means that Siebel applications can be deployed with zero maintenance required at the user desktop.

Siebel Thin Client in Java

An embodiment of the Siebel Java Thin Client uses 100 percent pure Java to support users accessing Siebel from Java-enabled environments. Like the Siebel Thin Client for Windows, the Siebel Java Thin Client offers full support for Siebel's highly interactive, browser-like user interface for enterprise sales, marketing, and service users, but adds support for non-Windows platforms.

Siebel Thin Client in HTML

Users outside the enterprise can access a richly featured, HTML-based version of Siebel Thin Client that adopts the look, feel, and branding of the enterprise Web site. This HTML-based thin client ideally is suited to novice and infrequent users who require a simple Web page interface so they can use Siebel applications with absolutely no prior training. Siebel Thin Client in HTML is the platform of choice for Siebel eBusiness applications for Internet-based selling, marketing, service, and channel management.

Siebel Object Manager: Supporting Enterprise Class Scalability

Siebel Object Manager manages the enterprise's business rules in the form of Siebel Business Objects, as highly configurable software representations of business concepts such as accounts, contacts, opportunities, and service requests. Siebel Thin Clients may connect to a Siebel Object Manager to access the application's business logic. Siebel Object Managers are hosted in Siebel's high-performance Siebel Server environment and deliver:

Multi-user Support.

Designed for enterprise class scalability and robustness, the multithreaded, multiprocessing Siebel Object Manager can support numerous thin client users. Each Siebel Object Manager can handle requests from multiple thin clients and share process overhead across all the thin clients to which it is connected. Each active thread in a Siebel Object Manager corresponds to an active client session. The state of each client is maintained by the Object Manager thread, thus avoiding the overhead of setting up a new session for each request. Siebel Object Managers running on multiple server machines are dynamically load balanced to serve incoming clients in an optimal and highly scalable manner.

Dynamic Load Balancing Across Multiple Servers.

The Siebel Server environment dynamically measures CPU load on each server running a Siebel Object Manager and directs requests to the least loaded Siebel Object Manager.

High Resilience and Availability.

As part of the Siebel Application Server environment, Siebel Object Manager benefits from Siebel's investments in high-resilience/high-availability features such as automatic failover across server machines and extensive server monitoring. If a Siebel Object Manager process fails, alternative Object Manager processes can be brought up to take over the clients of the failed process.

Full Support for Siebel Business Objects.

By supporting Siebel Business Objects, Siebel Object Manager leverages the customer's investments in configuring any Siebel Enterprise Application. The Siebel Object Manager-like all other components of the Siebel n-tiered, Web-based architecture—can be fully configured with Siebel Tools, a graphical application development and configuration tool. Because Siebel Object Manager supports the full range of Siebel Business Objects, enterprises configure their application only once and then can choose to deploy it over Siebel Thin Client or over Siebel 99 mobile, handheld, or connected clients—without writing separate configurations for each.

Common Administration Framework.

Siebel Object Manager uses the Siebel Server's administration framework for monitoring and administration, making it simple for server administrators to manage the Object Manager the same way they would manage other components of the Siebel Server.

Siebel Web Engine: High Performance HTML Generated on Demand

The Siebel Web Engine is a collection of small components that works with enterprise Web servers to generate the HTML Thin Client user interface dynamically, delivering highly cross-platform, very lightweight, personalized HTML pages to the end user's browser.

The Siebel Web Engine delivers HTML to the user's Web browser, allowing access from any browser that supports HTML. The Web Engine interprets templates that include any HTML necessary for capturing the enterprise's corporate identity, alongside Siebel Tags responsible for identifying the placement of Siebel user interface controls. Because these templates are familiar to any Web developer who uses HTML, they are easy to configure to reflect the needs of each enterprise using the HTML editor of choice.

The Siebel Web Engine and the Thin Client in HTML is a platform on which Siebel's customer-facing, Internet-based applications—such as Siebel eService—are based. In general, the HTML Thin Client delivers interfaces that are suited ideally to assisting novice users with access to customer, product, and service information maintained in Siebel Enterprise Applications.

Table 2 describes the Siebel Internet Architecture Features.

TABLE 2
Siebel Internet Architecture Features

| | | | |
|---|---|---|---|
| ✓ | SIEBEL THIN | | |
| | CLIENT FOR | | |
| | WINDOWS | | |
| | | ✓ | True thin client-all application logic |
| | | | is on midtier server |
| | | ✓ | Siebel user interface deployed through |
| | | | a Web browser |
| | | ✓ | Support for Microsoft Internet Explorer |
| | | | and Netscape Navigator |
| | | ✓ | Small user interface components |
| | | | dynamically downloaded to client |
| | | ✓ | Smart version checking of U1 |
| | | | components |
| | | ✓ | Applications served by scalable server- |
| | | | side Siebel Object Managers |
| | | ✓ | High interactivity user interface |
| | | ✓ | Display views configured in Siebel |
| | | | Tools |
| | | ✓ | Tight integration with Microsoft |
| | | | Windows applications |
| | | ✓ | Secure encrypted communication with |
| | | | Siebel Object Manager |
| | | ✓ | Compressed communication with Siebel |
| | | | Object Manager |
| ✓ | SIEBEL HTML | | |
| | THIN CLIENT | | |
| | | ✓ | Siebel Business Objects rendered in |
| | | | HTML |
| | | ✓ | Support for custom look, feel, and |
| | | | branding of intranet/Internet sites |
| | | ✓ | Support for Microsoft Internet Explorer |
| | | | and Netscape Navigator |
| | | ✓ | Native support for Web server APIs-no |
| | | | CGI |
| ✓ | SIEBEL OBJECT | | |
| | MANAGER | | |
| | | ✓ | Serving all thin clients |
| | | ✓ | Hosting of Siebel Business Objects |
| | | ✓ | Hosted as component in multithreaded |
| | | | Siebel Server |
| | | ✓ | Scalable to support large number of |
| | | | thin clients |
| | | ✓ | Dynamic load balancing of thin client |
| | | | connections |
| | | ✓ | Administration by Siebel Server |
| | | | Manager |
| | | ✓ | Application configuration maintained |
| | | | on server |
| | | ✓ | Server-side user authentication |
| | | ✓ | Server-side hosting of user preferences |
| | | ✓ | Strict enforcement of Siebel application |
| | | | visibility rules |
| ✓ | SIEBEL OBJECT | | |
| | INTERFACES | | |
| | | ✓ | Siebel User Interface available as an |
| | | | ActiveX control |
| | | ✓ | COM interfaces to Siebel Business |
| | | | Objects |
| | | ✓ | CORBA interfaces to Siebel Business |
| | | | Objects |

Siebel Remote and Distributed Architecture

Supporting Distributed Users

Support for geographically distributed users is a critically important requirement for comprehensive front office deployments. Users may be field-based sales and service professionals operating with laptop computers in a mobile environment, or those based in regional or satellite offices. Although they work remotely, these users have the same requirements for application functionality and data access as do their centrally located colleagues.

Siebel Enterprise Applications provide a complete, proven, deployment-ready solution for enterprise-wide data synchronization and replication among distributed users through two product modules:

Siebel Remote.

Synchronizes the central Siebel Database Server and File System with local versions on the computers of remote sales and service representatives who typically use laptop computers in a mobile environment. Siebel Remote is the only proven mobile database synchronization solution for the entire enterprise, and supports more mobile users in production today than any other comparable front office database synchronization product.

Siebel Replication Manager.

Replicates the central Siebel Database Server and File System with multi-user database servers and file systems, typically located in multiple satellite or regional offices. Siebel Replication Manager uses a hierarchical scheme to replicate subsets of the central data to one or more tiers of these regional nodes. A regional node also can be configured as a mirror copy containing all the central data.

Siebel Remote and Siebel Replication Manager provide transparent, fast, and robust data sharing across the enterprise, supporting truly enterprise-wide relationship management. These two products can provide Siebel users with a single, unified, consistent view of all customer information, regardless of where users are located geographically or how they operate.

Remote and Distributed Deployment Requirements

Siebel Remote and Siebel Replication Manager address all the data access requirements of remote and distributed deployments. These requirements include:

Seamless Data Sharing.

Supports global customer management, providing all required users across the enterprise with an automatically maintained, consistent set of customer data.

A Simple, Intuitive Interface.

Invokes and controls synchronization that also provides full control over each session.

Full User and Administrator Notification.

Alerts users to the results of the synchronization session and changes to key business data. This prevents confusion over the outcome of a synchronization session and ensures that attention can be focused easily on new or newly updated records.

Fast Synchronization Sessions.

Reduces user impact to an absolute minimum. This is critical to the individual user and to prevent contention among many users synchronizing concurrently. The speed of the synchronization session has been proven, many times over, to be a critical factor in user acceptance of the mobile solution.

A Robust Synchronization Mechanism.

Ensures accurate and consistent data even under severe error conditions common in mobile environments such as dropped telephone connections and dead laptop batteries.

Ease of Administration.

Ensures minimal administration costs and high quality of service to users even in very large deployments.

A scalable Architecture.

Meets all these requirements in enterprise-level deployments with tens of thousands of heterogeneous users. The solution must meet the needs of mobile and distributed users without imparting performance penalties on other types of connected users.

Seamless Data Sharing

Siebel Remote and Siebel Replication Manager provide totally transparent, user-controlled data sharing across all members of virtual customer teams enterprise-wide, completely addressing critical requirements for distributed deployments.

Siebel Remote and Siebel Replication Manager provide seamless data sharing across the enterprise using advanced technology. A complex set of algorithms, called routing rules, is used to determine the appropriate data visible to each user and which information is synchronized according to databases. The routing rules are based on user membership on virtual sales and service teams for key entities, and can include accounts, contacts, opportunities, and service requests. The routing rules encompass all related entities, including file attachments stored on the Siebel File System, to ensure that team members receive the complete set of data needed for effective customer management.

Teams of sales, marketing, and service professionals are defined as data in the Siebel Database. Teams are created automatically by the Siebel Assignment Manager server component for all new and updated data in these key entities. Teams also are under the full manual control of Siebel users, and can be modified at any time. Teams are defined for each record in these key entities; each record-level team can comprise any user from across the enterprise, providing complete flexibility in determining which users have access to the data for a given record.

Users may be provided differing levels of visibility to the same entity. depending on their team membership. For example, the members of an account team may be provided with full visibility to that account and all related records including opportunities, contacts, and products. On the other hand, a user may be added to the team for a specific opportunity, which will allow that user to see summary-level information about the related account, but not other opportunities related to that account.

The Siebel Assignment Manager server component is used to automate team assignment and maintenance using assignment rules. Assignment rules support a broad range of algorithms for matching users with teams based on an unlimited number of criteria, providing flexibility in controlling the automated access to accounts, contacts, opportunities, service requests, and other key entities.

Just as adding a team member automatically provides that team member with full data visibility, the removal of a team member will result in the deletion of all related data from their laptop or regional database at the next synchronization session. This maintains tight data security and closely manages database size, which is particularly important in environments where reassignment is common. Together with Siebel Assignment Manager, these capabilities provide complete support for territory realignments and other organizational changes, allowing the results to be distributed seamlessly across the enterprise.

Through the Siebel routing rules, Siebel Remote and Siebel Replication Manager enable user-driven, flexible sharing of data across enterprise-wide teams. A given account, for example, may have a local sales representative and sales consultant, a key or national account manager, several support engineers, and an executive sponsor assigned to the team, whereas another account has a team comprising of completely different members. All team members have visibility regarding the same set of data and the same comprehensive picture of the account. The same capabilities apply to contacts, opportunities, service requests, and other key entities.

Siebel routing rules are defined as data-driven objects in the Siebel Repository and can be modified and seamlessly upgraded using Siebel Tools to further refine the rules implemented in Siebel's complete, out-of-the-box solution.

Siebel's data sharing capabilities stand in direct contrast to those of competing solutions that determine data visibility at the physical table level using hard-coded team lists. These lists implement fixed teams with one-to-one relationships to employees and to key entities. Every entity and every user typically adheres to the same set of fixed teams, providing no flexibility to assign others on an as needed basis to manage an account, opportunity, service request, or other entity.

Ease of Use

Siebel Remote delivers an intuitive, user-friendly interface for controlling synchronization sessions atop this powerful synchronization technology. Siebel Remote users, employing the same Siebel Dedicated Client with the same functionality as connected users, have full control over synchronization sessions, which can be started from within the Siebel Client or invoked as a stand-alone program called from an external scheduler or upon Windows start-up, for example.

To synchronize, mobile users simply plug a phone line or network connection into their laptop (or desktop) and push the Synchronize button. With a single mouse click, users can synchronize all database and file changes with the central servers, or they can choose to perform only parts of a full session: sending or retrieving database changes, retrieving only selected files, or applying database changes retrieved during a previous synchronization session.

Through this dialog, the Siebel Remote mobile user has complete control over the exact steps executed during the synchronization session. For example, a sales representative about to board a plane can elect to retrieve only the latest version of a product presentation from the Siebel Encyclopedia to present during a client visit. The dialog displays the number of items remaining to be completed for each step, as well as the time remaining to complete the total session, keeping the mobile user fully informed of synchronization status throughout the session.

The enterprise class robustness of the Siebel Remote synchronization technology allows a synchronization session to be interrupted at any point without corrupting data or causing inconsistent results. A user may interrupt any step during processing and proceed to the next step or abort the entire session; synchronization simply continues transparently from the next step or from the point of interruption.

To streamline the synchronization process further, Siebel Remote can be configured to manage dial-up network connections to the Siebel Enterprise Server automatically. This is particularly useful when invoking the stand-alone synchronization program from an external scheduler; the synchronization session will begin at the scheduled time, dial the Siebel Enterprise Server automatically, drop the network session once transmission is complete, and then exit upon completion of the synchronization session.

As a multi-user server-to-server synchronization product, Siebel Replication Manager does not rely on user initiation of synchronization sessions. Instead, synchronization sessions are managed by the Siebel Replication Agent component that operates on a Siebel Server in the regional or satellite office. (For smaller regional offices, the Siebel Server is often co-located with the Siebel Database Server.) Siebel Replication Agent is configured to synchronize automatically with the central Enterprise Server on a fixed frequency, which may be every few minutes or every few days, depending on business requirements. Siebel Replication Agent provides the same automatic network management as Siebel Remote, enabling it to work effectively in satellite or regional offices that do not have permanent network connectivity to the central site.

Full User Notification

Siebel Remote and Siebel Replication Manager users alike are kept fully informed about data changes resulting from synchronization. Many Siebel Client screens include the new data indicator which flags new or newly updated records for each user. As with all other fields on a Siebel screen, this indicator can be used in query by example or in a stored predefined query, allowing the Siebel user to locate data changes requiring immediate attention quickly.

The Siebel Remote mobile user can view complete details about each synchronization session in the Siebel Remote Status screen. This client screen shows the detailed results of all synchronization sessions including the details of any conflicts automatically identified and resolved by Siebel Remote during the synchronization session.

Fast Synchronization Sessions

Siebel Remote and Siebel Replication Manager share the same advanced, mature synchronization technology. This technology incorporates several key features to ensure fast, scalable synchronization performance.

Field-level, Net Change Synchronization to Exchange and Apply Changes Only to Fields that have been Changed.

This ensures that the absolute minimum of data is transmitted between client and server, minimizes network bandwidth requirements and transmission times, and allows efficient update processing for applying the changes.

Competing synchronization solutions use a record-level mechanism that exchanges each entire record that has been modified, even if the change affects only a single field. Records for common entities can have several hundred fields, resulting in more data being transmitted between the client and server and a corresponding increase in transmission time and bandwidth consumption. When applying record-level changes to a database, a user cannot update existing records; instead existing records must be deleted from the database, and the entire updated record must be inserted. This process is extremely input/output intensive and results in very slow merge times on the client.

All Changes are Preprocessed in the Central Siebel Enterprise Server for Immediate Retrieval.

Once connected to the Enterprise Server, the Siebel Remote user or Siebel Replication Agent needs only to retrieve these changes and transmit its own local changes before dropping the network connection. This requires minimal network time and greatly reduces contention for server-side resources among multiple synchronizing clients.

Competing synchronization solutions require each synchronizing client to execute queries that “sweep” the entire server database during the synchronization session, leading to greatly increased connection time for each user and enormous potential contention for database server and other resources during peak synchronization times. During times of peak demand, such as Monday mornings or at critical points during forecasting cycles, this approach quickly can lead to database server “meltdown” when the workload of multiple synchronizing users outstrips the capacity of the database server.

Synchronization Runs Entirely as a Background Process for Both Siebel Remote and Siebel Replication Manager.

Siebel users continue to work uninterrupted in Siebel or other applications while synchronization is underway. This reduces to zero the effect and end user wait time for already fast synchronization sessions. It also ensures that mobile sales or service representatives are able to use their laptops to full advantage.

Robust Synchronization Mechanism

The synchronization technology shared by Siebel Remote and Siebel Replication Manager is impervious to the error conditions common in mobile and distributed environments such as dropped dial-in lines and unexpected client or server shutdowns. Synchronization sessions can be interrupted at any point, for any reason, without the possibility of losing or corrupting data or causing inconsistent results.

Siebel databases are tracked as synchronization transactions. Following a standard store-and-forward model, these transactions are written into files that are used to transport them between databases. Both transactions and the files that contain them are tracked by several control mechanisms that include sequential numbering and CRC verification to ensure that each database receives and successfully applies all the transactions in the exact order in which they were applied in the originating database.

Transaction-level processing allows the synchronization process to be interrupted at any point without danger of data loss or corruption. If transmission of a file fails or a file is deleted accidentally before being applied, Siebel Remote or Siebel Replication Manager will retrieve another copy of that file during the next synchronization session. Guarding against accidental data loss, files are not deleted from either client or server until the Siebel Solution has confirmed that all transactions in them have been applied successfully by the receiving database.

Transactions are applied to each database in the exact order as in the initiating database, maintaining transaction-level integrity and allowing the process to be stopped and restarted from the next transaction at any time. Data integrity is assured even if a synchronization session does not run to completion, making Siebel Remote both resilient and highly efficient. Dial-in lines are notorious for dropping unexpectedly, but rather than abort the entire session when this occurs, as is the case with snapshot-based “all or nothing” solutions, Siebel Remote applies all transactions retrieved during a synchronization session and resumes from the point of failure in the next session.

To ensure consistent results across every synchronization session, Siebel Remote automatically handles both conflict detection and conflict resolution. During the session, the processes applying changes on both client and server identify any conflicting, field-level changes. Any conflicts are resolved automatically using administrator-configured rules.

Field-level conflicts are identified and resolved during the single synchronization session, eliminating the need for the user to perform a second synchronization in order to resolve conflicts. Both the user and the Siebel administrator are provided with a complete list of all resolved conflicts.

Other competing synchronization solutions either provide no conflict handling, virtually ensuring data corruption, or write record-level conflicts to a log that must then be processed and resolved by an administrator who typically is unaware of the appropriate way to resolve the conflict. The record-level detection ensures that many false conflicts will be logged, whereas the synchronization results remain inconsistent and confusing to users until an administrator is able to clear the entire log.

Ease of Administration

Embodiments of the Siebel Remote and Siebel Replication Manager provide a complete set of administrative features that complements the Siebel solutions' ease of use and overall robustness to help ensure seamless service and low-cost administration for even the largest global enterprise deployments.

Siebel Remote's administrative features include:

Full Integration with Siebel Anywhere.

Siebel Remote and Siebel Replication Manager take full advantage of the capabilities of Siebel Anywhere, Siebel's software distribution and maintenance solution.

When a brand new Siebel Remote user first starts the Siebel Client, the Siebel Anywhere Upgrade Wizard is launched to retrieve and initialize the local database automatically from the Siebel Enterprise Server.

Should the user's database later be re-extracted by the Siebel administrator, the Upgrade Wizard will be launched at the next synchronization session to install the new local database. This automatic initialization eliminates the need for administrator involvement in setting up Siebel Remote mobile users.

For subsequent upgrades, users are notified automatically of new software updates at synchronization time. If they choose to upgrade, they immediately launch into the

Siebel Anywhere Upgrade Wizard, providing them with an immediate, intuitive, and seamless user experience to receive new software releases. Siebel Anywhere can automatically distribute to Siebel Remote and Siebel Replication Manager Upgrade Kits containing changes to the database schema or new versions of the Siebel software, customer configuration, or any third-party applications or utilities. Upgrade kits are retrieved automatically during synchronization and applied using the Upgrade Wizard, fully automating all Siebel software maintenance for both Siebel Remote and Siebel Replication Manager implementations.

Complete Server-side Monitoring.

The Siebel Remote Administration screens collect comprehensive data about the synchronization sessions of each Siebel Remote mobile user and Siebel Replication Manager regional database. In addition to a server-side version of the synchronization details in the mobile user's local Siebel Remote Status screen, the Siebel Remote Administration views track such information as the number of bytes. transactions, and files sent and received during each session; the time taken for each step; the starting and current size of the local database; and the amount of free disk space available on each user's PC.

These administration screens provide the Siebel administrator with the complete set of information required for proactive management of large mobile user bases. For example, the Siebel administrator can use query by example in the Siebel Client or create a report that identifies users who do not synchronize regularly, are running out of local disk space, or have much longer than average synchronization times. Having this information readily available enables the administrator to contact these users to head off potential future problems or to analyze fully the effect of deploying additional Siebel features and options requiring additional data.

The Siebel Enterprise Server components that support Siebel Remote and Siebel Replication Manager, including the Replication Agent, may be fully integrated with the Siebel Server Manager. From a single point, the Siebel administrator has a graphical user interface for full monitoring and control over all Enterprise Server components across the enterprise. A single, centrally located Siebel administrator can use Server Manager to monitor the status of the Replication Agent component and Siebel Replication Manager synchronization on each of many regional databases worldwide. This dramatically reduces administration costs and increases system availability and quality of service.

Scalable Architecture

The server-side processes that support Siebel Remote and Siebel Replication Manager are implemented as components in the Siebel Enterprise Server, Siebel's highly scalable middle tier application server. For maximum performance and scalability, each server component is implemented as a multithreaded application that can process multiple tasks or service multiple Siebel Remote mobile users simultaneously. Siebel Remote users' databases then can be distributed across multiple components operating on multiple Siebel Servers within a single Enterprise Server, providing unlimited scalability of the middle tier to meet the needs of very large distributed deployments.

The use of Enterprise Server components also ensures a high degree of Siebel Database Server scalability. During synchronization sessions, mobile users and replication agents do not open synchronous connections with the central database server, ensuring a low load on the Siebel Database Server and eliminating usage spikes that could negatively affect database response time for other users during peak synchronization periods. Tens of thousands of mobile users can be served by connections to the Siebel Database Server, providing several magnitudes of order reduction in database server load.

The Siebel Enterprise Server components also use sophisticated memory- and file-based caches to reduce load on the database server further, as well as to enhance the performance of each component. The Siebel Enterprise Server component operations can be executed against data held in local memory in a fraction of the time otherwise required to execute them against a remote relational database. And the data is shared across multiple processing steps rather than being continually retrieved from the database server.

Siebel's synchronization technology has clear, proven advantages in scalability and performance compared to alternative approaches that require each mobile user to log directly into the database during synchronization in order to sweep each table for changes. Such architectures place extreme loads on the database server during peak use periods, such as during forecast deadlines, when many users need to synchronize simultaneously, to the detriment of both mobile and connected users. These architectures also limit upward scalability to the capacity of the single database server, whereas Siebel can support an unlimited number of Siebel Servers operating against relatively small (or large) database servers.

The weaknesses of these alternative direct-connect architectures are exacerbated further by the approach used to retrieve data changes for synchronization. These alternative solutions “sweep” each table in the database to find data dated later than the user's last synchronization time stamp. The multiplicative effects of many Structured Query Language (“SQL”) statements per user, with many users synchronizing simultaneously, increase the fundamental scalability problem and the risk of database server “meltdown” during peak usage periods. As hardware and database scalability reach a hard limit, these architectures are likely to fail when faced with thousands of simultaneous database connections.

Siebel Distributed Architecture

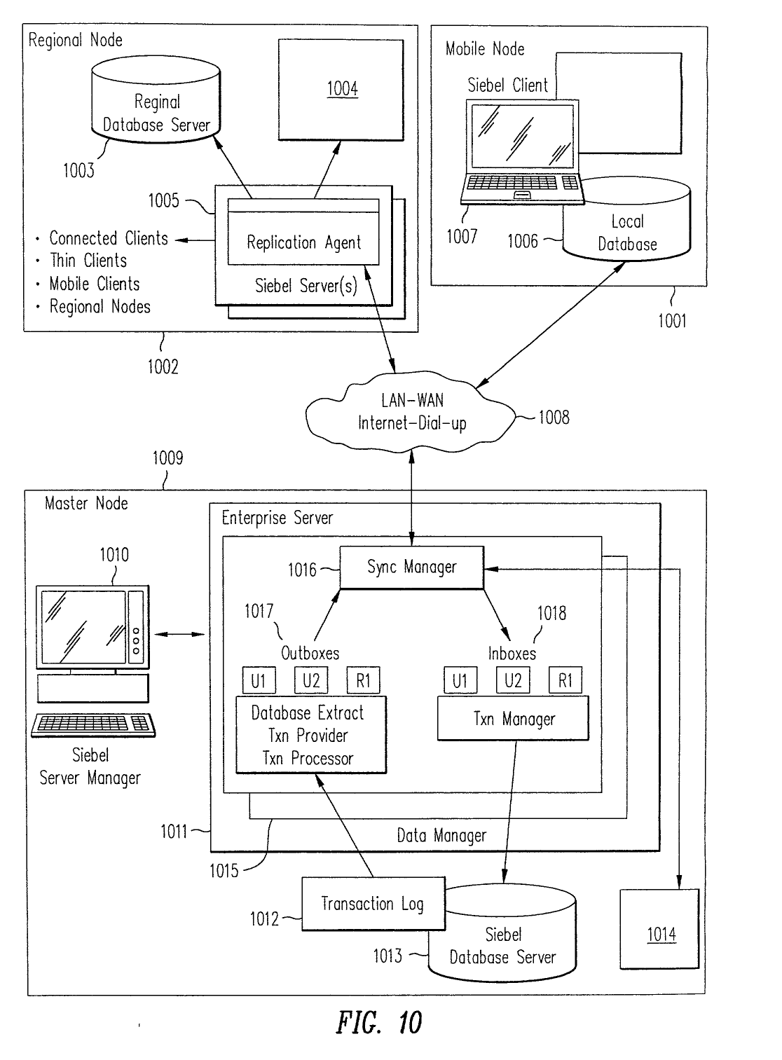

FIG. 10 illustrates architectural elements of Siebel Remote and Siebel Replication Manager, according to an embodiment of the invention.

Three types of nodes are supported in a distributed deployment of Siebel Enterprise Applications:

The master node includes the central Siebel Enterprise Server, database server, and file system. A given Siebel deployment has one master node.

Mobile nodes support the Siebel Dedicated Client operating against a single user local database and file system. Each mobile node is extracted from, and synchronizes with, either the master node or a regional node using Siebel Remote.

Regional nodes support mobile, dedicated, and thin clients operating against a multi-user database server and file system. Regional nodes may be children of the master node, as depicted in the previous figure, or they may be deployed in multiple tiers, where the regional nodes in the second tier are children of first-tier regional nodes, which, in turn, are children of the master node. Regional nodes use Siebel Replication Manager to synchronize periodically against the database server and file system in the parent node.

A regional node may contain a subset of the database server and file system data of its parent node, using the Siebel routing rules to limit data according to the visibility of the users assigned to the regional node. Or it may be a mirror copy containing all the data of its parent node. All changes made on the regional node automatically are uploaded to its parent at synchronization time.

Siebel Master Node

Every Siebel deployment has a central Siebel Database Server, Siebel File System, and Siebel Enterprise Server. Together, these components make up the master node. They store the complete set of enterprise data, which is synchronized with mobile and regional nodes that are children of the master node, and is available online to Siebel connected and Web clients operating against the master node.

The components within the master node are as follows:

The Siebel Database Server.

Stores the total set of database records for the Siebel deployment. In addition to this business data, the database server also contains a master transaction log that records at a net change, field level all modifications made to the database server, either by Siebel users or by Siebel Server components.

The Siebel File System.

Stores attachments, correspondence, templates, and other types of physical files for all Siebel users.

The Siebel Enterprise Server comprises one or more Siebel Servers executing the Siebel Remote and Siebel Replication Manager components, as well as other components providing workflow and process automation and other server-side capabilities. Each mobile or regional node that is a child of the master node has an inbox and an outbox. on a Siebel Server within the central Enterprise Server (represented in the previous figure as U I, U2, and R I). These directories are the store in Siebel's store-and-forward synchronization architecture, temporarily holding net change data to be synchronized to the child nodes.

Several Enterprise Server components manage the contents of the inboxes and outboxes:

The Database Extract Component.

Creates the initial database for mobile or regional nodes and places it into the node's outbox, from where it is retrieved when the database is initialized. The initial database contains all the data visible to the node at the time of extract. Once the database is extracted, it is maintained by applying net change transactions. Database Extract is run as needed by the Siebel administrator.

The Transaction Processor Component.

Reads the master transaction logon the Siebel Database Server and prepares transactions for visibility checking and routing by a transaction router. It also purges the transaction log once transactions have been routed to all applicable nodes.

The Transaction Router Component.

Applies the Siebel routing rules to transactions in the transaction log to determine which nodes have visibility. writing the transactions to compressed files in the appropriate outbox directories on the Siebel Server.

The Transaction Merger Component.

Applies transactions that have been uploaded during synchronization to each child node's inbox. During the merge process, Transaction Merger detects and automatically resolves any conflicts in the uploaded transactions.

Synchronization sessions are managed by the Synchronization Manager component which controls the synchronization sessions of all mobile and regional nodes. At synchronization time, each node connects to the Synchronization Manager which performs the following actions:

Transmits any waiting transaction files from the node's outbox

Receives the node's changes and writes them to its inbox

Retrieves any requested files from the Siebel File System

Synchronization Manager is a multithreaded component that automatically spawns a thread to handle multiple concurrent synchronization sessions. The synchronizing node does not open a connection to the database server, which greatly enhances scalability by preventing large, peak loads on the database server as many nodes synchronize concurrently.

A final administrative component, Generate New Database prepares the template database used for initializing the local database schema on a mobile client. The component reads the database schema definition from the Siebel Repository, including all customizations, and creates Siebel tables and indexes in the template database file. The Siebel Administrator can specify alternative character sets and sort orders when creating the template file to better support users operating in different regions worldwide. Generate New Database is executed as needed by the Siebel administrator.

Siebel Mobile Node

A mobile node consists of the Siebel Client operating against a local database and file system. It typically is installed on the laptop computer of a field-based sales or service representative, though it also may be used from the desktops of office-based users. The database against which the Siebel Client operates is specified at start-up time, allowing the same Siebel Client to operate directly against a master or regional node. The ability to operate against either a local or server-based database directly meets the needs of nomadic users who periodically operate from an office location but are mobile at other times.

In both mobile and connected modes, the mobile user has access to the same data and functionality of the connected Siebel Client. The Siebel Remote client software is used periodically to synchronize the mobile node with its parent, using a modem across public telephone lines, a local area network (“LAN”), a wide area network (“WAN”) the Internet, or another network connection. The Siebel Remote client can be synchronized from within the Siebel Client application or it can run as an external stand-alone program that can be started automatically by an external scheduler to begin the synchronization process.

Like the Siebel Database Server, the local database maintains a master log of all changes made by the mobile user. During the synchronization session, the Siebel Remote client communicates directly with the Synchronization Manager component on the Siebel Server to:

Send local changes to the node's inbox on the Siebel Server.

Retrieve waiting transactions from the node's outbox.

Exchange requested or modified files with the Siebel File System. Once transmission and retrieval of transactions and files is complete, Siebel Remote no longer needs the network connection to the Siebel Server, and will drop the connection if it initiated it.

Apply transactions retrieved from the Siebel Server, identifying and resolving any conflicts automatically as the transactions are applied to the local database. Application of transactions is separate from retrieval to ensure the shortest possible connection time. The user also can elect to apply changes at a later point. Upon start-up of the Siebel Client, the user automatically is notified if previously retrieved transactions still await application, to ensure that retrieved transactions are applied successfully.

Siebel Regional Node

A regional node consists of a Siebel Enterprise Server with one or more Siebel Servers, a database server, and a file system. A regional node can support all types of Siebel Clients: thin client users, Siebel Remote mobile clients, and Siebel Connected Clients, and also can support child regional nodes. Siebel Replication Manager is used to synchronize the regional database server and file system periodically with the parent node.

Siebel Replication Manager allows complete flexibility in providing Siebel users with local access to database servers and file systems, as well as in distributing large workloads across multiple database servers. Typically, Siebel Replication Manager is used to provide access to a local database server for better performance or more availability than network dependencies would allow if they were to operate against a remote, central database server.

Each regional node is created as the child of the master node or another regional node in a hierarchical model. The regional node may contain a full copy of the parent node's data, or it may apply the Siebel routing rules for the users assigned to the regional node to limit the data to a subset of the parent. User assignment to regional nodes is under complete control of the Siebel administrator. A single user may be assigned to multiple regional nodes, as well as having an account on the master node and a mobile database. Siebel Remote and Siebel Replication Manager ensure that the user's data is automatically maintained across all databases.

Siebel Replication Manager uses the same field-level, net change synchronization technology as Siebel Remote. The regional database server maintains a master transaction log, just as on the central database server.

Replication with a regional node's parent, which may be the master node or another regional node, is handled by the Replication Agent component operating on the regional enterprise server. The Replication Agent automatically synchronizes the regional node with its parent at a Siebel administrator-defined interval. For some sites, this may occur every 20 minutes; at others, this may occur once daily or even less frequently, depending on business requirements.

At synchronization time, the Replication Agent component communicates with the Synchronization Manager component on the parent enterprise server to perform the following:

Transmit all changes since the last synchronization to the parent node

Retrieve all changes waiting in the regional node's outbox on the parent enterprise server

Exchange requested or modified files between the parent and regional file systems

Apply all retrieved changes, identifying and automatically resolving any conflicts as the changes are applied to the regional database server

Like the Siebel Remote client software, the Replication Agent component can be configured to manage network connectivity automatically with the parent node, creating a dial-in connection at the start of the synchronization session and dropping it once all changes have been exchanged successfully.

The regional node also can support Siebel Remote mobile users and child regional nodes. In this configuration, the regional enterprise server executes the server components described for the master node above-Transaction Processor, Transaction Router, Transaction Merger, and Synchronization Manager- and acts as the parent node in the synchronization session.

In Siebel Remote and Siebel Replication Manager, Siebel Systems provides the only proven, enterprise class synchronization solutions that meet all the needs of mobile and distributed deployments. Siebel Remote and Siebel Replication Manager provide complete capabilities for both mobile user and server-to-server synchronization. These solutions are fully production proven at several of the largest front office deployments.

Siebel Remote and Siebel Replication Manager are configured completely out-of-the-box for quick and easy deployment. They provide fast, scalable, and robust synchronization and ensure transparent data access for all front office users enterprise-wide. These products may be fully integrated with Siebel Anywhere to support rapid application deployment, low maintenance costs, and seamless upgrades to thousands or tens of thousands of distributed users.

While the invention has been described with respect to certain preferred embodiments and exemplifications, it is not intended to limit the scope of protection thereby, but solely by the claims appended hereto.

we claim:

1. A client server system comprising a thin client interface residing on at least one client and a an object manager and an application residing on one or more servers, said object manager interposed between said client and said application server, and said application server comprising one or more of business objects, and business components.

2. The client-server system of claim 1 wherein the application server comprises a database server.

3. The client-server system of claim 1 wherein object manager run-time engines that operate on the business objects and business components.

4. The client-server system of claim 3 wherein the business objects and business components comprise applets and application objects.

5. The client-server system of claim 3 wherein object manager run time engines enforce repository-defined business processes and rules.

6. The client-server system of claim 1 having application objects executing on the client.

7. The client-server system of claim 1 having user interface objects executing on the client.

8. The client-server system of claim 1 comprising session-based network protocols connecting the client to the object manager.

9. A method of connecting a client and one or more servers in a client server network, wherein said client is a thin client, and said one or more servers comprise an object manager and an application residing on one or more servers, said object manager interposed between said client and said application server, and said application server comprising one or more of business objects, and business components, instantiating said one or more business objects and establishing a session based network connection between the thin client and the one or more servers.

10. The method of claim 9 comprising instantiating object manager run-time engines to operate on the business objects and business components.

11. The method of claim 9 wherein the business objects and business components comprise applets and application objects.

12. The method of claim 9 wherein object manager run time engines enforce repository-defined business processes and rules.

13. The method of claim 9 wherein application objects execute on the client.

14. The method of claim 9 wherein the user interface objects execute on the client.
